(19) United States
(12) Patent Application Publication
(10) Pub. No.: US 2025/0364775 A1
(43) Pub. Date: Nov. 27, 2025

(54) LASER DEVICE, EXPOSURE APPARATUS, AND ELECTRONIC DEVICE MANUFACTURING METHOD

(71) Applicant: Gigaphoton Inc., Oyama-shi (JP)

(72) Inventors: Izumi TANAKA, Oyama-shi (JP); Osamu WAKABAYASHI, Oyama-shi (JP)

(73) Assignee: Gigaphoton Inc., Oyama-shi (JP)

(21) Appl. No.: 19/292,609

(22) Filed: Aug. 6, 2025

Related U.S. Application Data
(63) Continuation of application No. PCT/JP2023/012791, filed on Mar. 29, 2023.

(51) Int. Cl. H01S 3/136; H01S 3/10

(52) U.S. Cl. CPC H01S 3/136; H01S 3/10038

(57) ABSTRACT

A laser device includes a laser oscillator configured to generate pulse laser light, an actuator configured to adjust a laser light parameter of the pulse laser light, and a laser control processor configured to correct an operation parameter value of the actuator so that a difference between a measurement value and a target value of the laser light parameter becomes small based on a change pattern of a pulse time interval of the pulse laser light continuously changing within a burst of burst oscillation in accordance with a command of an exposure apparatus, and control the actuator.

### CROSS-REFERENCE TO RELATED APPLICATIONS

The present application is a continuation application of International Application No. PCT/JP2023/012791, filed on Mar. 29, 2023, the entire contents of which are hereby incorporated by reference.

### BACKGROUND

### 1. Technical Field

The present disclosure relates to a laser device, an exposure apparatus, and an electronic device manufacturing method.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser device for exposure, a KrF excimer laser device for outputting laser light having a wavelength of about 248 nm and an ArF excimer laser device for outputting laser light having a wavelength of about 193 nm are used.

The KrF excimer laser device and the ArF excimer laser device each have a large spectral line width of about 350 to 400 pm in natural oscillation light. Therefore, when a projection lens is formed of a material that transmits ultraviolet rays such as KrF laser light and ArF laser light, there is a case in which chromatic aberration occurs. As a result, the resolution may decrease. Then, a spectral line width of laser light output from the gas laser device needs to be line-narrowed to the extent that the chromatic aberration can be ignored. For this purpose, there is a case in which a line narrowing module (LNM) including a line narrowing element (etalon, grating, and the like) is provided in a laser resonator of the gas laser device to line-narrow a spectral line width. A gas laser device with a narrowed spectral line width is referred to as a line narrowing gas laser device.

### LIST OF DOCUMENTS

### Patent Documents

Patent Document 1: US Patent Application Publication No. 2018/309259
Patent Document 2: US Patent Application Publication No. 2017/179677

### SUMMARY

A laser device according to an aspect of the present disclosure includes a laser oscillator configured to generate pulse laser light, an actuator configured to adjust a laser light parameter of the pulse laser light, and a laser control processor configured to correct an operation parameter value of the actuator so that a difference between a measurement value and a target value of the laser light parameter becomes small based on a change pattern of a pulse time interval of the pulse laser light continuously changing within a burst of burst oscillation in accordance with a command of an exposure apparatus, and control the actuator.

An exposure apparatus according to an aspect of the present disclosure is an exposure apparatus connectable to a laser device including a laser oscillator that generates pulse laser light, an actuator that adjusts a laser light parameter of the pulse laser light, and a laser control processor that controls the actuator. The exposure apparatus includes a projection optical system configured to form an image on a wafer surface using the pulse laser light output from the laser device; and an exposure control processor configured to acquire a measurement value of the laser light parameter, correct an operation parameter value of the actuator so that a difference between the measurement value and a target value becomes small based on a change pattern of a pulse time interval of the pulse laser light continuously changing within a burst of burst oscillation, and output the corrected operation parameter value to the laser device.

An electronic device manufacturing method according to an aspect of the present disclosure includes generating pulse laser light using a laser device, outputting the pulse laser light to an exposure apparatus, and exposing a photosensitive substrate to the pulse laser light in the exposure apparatus to manufacture an electronic device. Here, the laser device includes a laser oscillator configured to generate the pulse laser light, an actuator configured to adjust a laser light parameter of the pulse laser light, and a laser control processor configured to correct an operation parameter value of the actuator so that a difference between a measurement value and a target value of the laser light parameter becomes small based on a change pattern of a pulse time interval of the pulse laser light continuously changing within a burst of burst oscillation in accordance with a command of the exposure apparatus, and control the actuator.

An electronic device manufacturing method according to an aspect of the present disclosure includes generating pulse laser light using a laser device including a laser oscillator configured to generate the pulse laser light, an actuator configured to adjust a laser light parameter of the pulse laser light, and a laser control processor configured to control the actuator; outputting the pulse laser light to an exposure apparatus including a projection optical system configured to form an image on a wafer surface using the pulse laser light output from the laser device and an exposure control processor configured to acquire a measurement value of the laser light parameter, correct an operation parameter value of the actuator so that a difference between the measurement value and a target value becomes small based on a change pattern of a pulse time interval of the pulse laser light continuously changing within a burst of burst oscillation, and output the corrected operation parameter value to the laser device; and exposing a photosensitive substrate to the pulse laser light in the exposure apparatus to manufacture an electronic device.

### BRIEF DESCRIPTION OF THE DRAWINGS

Embodiments of the present disclosure will be described below merely as examples with reference to the accompanying drawings.

FIG. 1 schematically shows the configuration of an exposure system of a comparative example.

FIG. 2 schematically shows the configuration of a laser device according to the comparative example.

FIG. 3 shows an example of a semiconductor wafer exposed by the exposure system.

FIG. 4 shows an example of a trigger signal transmitted to a power source.

FIG. 5 shows, together with FIGS. 6 and 7, how the position of a scan field changes with respect to the position of pulse laser light.

FIG. 6 shows, together with FIGS. 5 and 7, how the position of the scan field changes with respect to the position of the pulse laser light.

FIG. 7 shows, together with FIGS. 5 and 6, how the position of the scan field changes with respect to the position of the pulse laser light.

FIG. 8 shows a procedure of sequentially exposing a plurality of scan fields.

FIG. 9 is a graph showing changes in a velocity of a workpiece table and a repetition frequency when the scan field is exposed in the comparative example.

FIG. 10 is a graph showing changes in the velocity of the workpiece table and the repetition frequency during on-acceleration exposure.

FIG. 11 is a graph showing changes in the repetition frequency and a measurement value of a laser light parameter in the comparative example.

FIG. 12 is a graph showing changes in the repetition frequency that changes continuously and the measurement value of the laser light parameter.

FIG. 13 is a graph showing the measurement value of the laser light parameter in a first embodiment.

FIG. 14 schematically shows the configuration of the laser device according to the first embodiment.

FIG. 15 is a flowchart of laser control in the first embodiment.

FIG. 16 is a flowchart showing a first example of processing of acquiring time-series data of a pulse time interval.

FIG. 17 is a flowchart showing a second example of processing of acquiring the time-series data of the pulse time interval.

FIG. 18 shows an example of the time-series data of the pulse time interval.

FIG. 19 is a flowchart showing an example of processing of acquiring a target value of the laser light parameter.

FIG. 20 shows an example of the target value of the laser light parameter.

FIG. 21 is a flowchart showing a first example of processing of acquiring a data set of a correction parameter value.

FIG. 22 is a flowchart showing a second example of processing of acquiring a data set of the correction parameter value.

FIG. 23 is a flowchart showing an example of processing of updating the correction parameter value while performing burst oscillation once.

FIG. 24 is a flowchart showing an example of processing of calculating a corrected operation parameter value.

FIG. 25 shows an example of a parameter table.

FIG. 26 is a flowchart showing an example of processing of calculating the operation parameter value corresponding to the target value.

FIG. 27 is a graph exemplifying a method of calculating the operation parameter value from the relationship between the operation parameter value and a value of the laser light parameter.

FIG. 28 is a flowchart showing an example of processing of calculating the correction parameter value for the next burst.

FIG. 29 is a flowchart showing an example of processing of calculating a control gradient.

FIG. 30 is a graph exemplifying a method of calculating the control gradient from the relationship between the operation parameter value and the value of the laser light parameter.

FIG. 31 is a flowchart of the laser control in a first modification of the first embodiment.

FIG. 32 is a flowchart showing an example of processing of performing burst oscillation once.

FIG. 33 is a flowchart showing an example of processing of acquiring the data set of the correction parameter value in a second modification of the first embodiment.

FIG. 34 is a flowchart showing an example of processing of acquiring the relationship between the operation parameter value and the value of the laser light parameter in the second modification of the first embodiment.

FIG. 35 shows an example of the trigger signal in first and second adjustment oscillation.

FIG. 36 shows an example of the relationship between the operation parameter value and the value of the laser light parameter acquired by the second adjustment oscillation.

FIG. 37 is a flowchart of the laser control in a second embodiment.

FIG. 38 is a flowchart showing an example of processing of acquiring the target value of the laser light parameter.

FIG. 39 shows an example of the target value of the laser light parameter.

FIG. 40 is a flowchart showing an example of processing of acquiring the data set of the correction parameter value.

FIG. 41 is a flowchart showing an example of processing of updating the correction parameter value while performing burst oscillation once.

FIG. 42 shows an example of the parameter table.

FIG. 43 is a flowchart showing an example of processing of calculating the corrected operation parameter value.

FIG. 44 is a graph exemplifying a method of calculating the operation parameter value from the relationship between the operation parameter value and the value of the laser light parameter.

FIG. 45 is a graph exemplifying a method of calculating the operation parameter value from the relationship between the operation parameter value and the value of the laser light parameter.

FIG. 46 is a graph exemplifying a method of calculating the operation parameter value from the relationship between the operation parameter value and the value of the laser light parameter.

FIG. 47 is a flowchart showing an example of processing of calculating the correction parameter value for the next burst.

FIG. 48 schematically shows the configuration of the laser device according to a third embodiment.

FIG. 49 is a flowchart of the laser control in the third embodiment.

FIG. 50 is a flowchart showing an example of processing of updating the correction parameter value while performing burst oscillation once.

FIG. 51 is a flowchart showing an example of processing of calculating a corrected set voltage value and a corrected set value.

FIG. 52 is a flowchart showing an example of processing of calculating the correction parameter value for the next burst.

FIG. 53 is a flowchart of the laser control in a modification of the third embodiment.

FIG. 54 is a flowchart showing an example of processing of performing burst oscillation once.

FIG. 55 schematically shows the configuration of the laser device according to a fourth embodiment.

FIG. 56 is a graph showing the relationship between a delay time of a second discharge timing with respect to a first discharge timing and a spectral line width of the pulse laser light output from a laser amplifier.

FIG. 57 schematically shows the configuration of the laser device according to a fifth embodiment.

FIG. 58 schematically shows the configuration of an exposure apparatus and the laser device according to a sixth embodiment.

### DESCRIPTION OF EMBODIMENTS

### <Contents>

1. Comparative example
   1.1 Configuration of exposure apparatus 100
   1.2 Operation of exposure apparatus 100
   1.3 Configuration of laser device 1
   1.4 Operation of laser device 1
   1.5 Step-and-scan exposure
   1.6 Problem associated with change in repetition frequency f
2. Laser device 1a using correction parameter value ΔAc for each burst oscillation pulse
   2.1 Concept
   2.2 Configuration
   2.3 Operation
      2.3.1 Main flow
      2.3.2 Acquisition of time-series data of pulse time interval ΔT
      2.3.3 Acquisition of target value Lt of laser light parameter L
      2.3.4 Acquisition of data set of correction parameter value ΔAc
      2.3.5 Burst oscillation and update of correction parameter value ΔAc
         2.3.5.1 Calculation of corrected operation parameter value Ac(k)
         2.3.5.2 Calculation of correction parameter value ΔAc(k) for next burst
   2.4 Effect
3. Laser device 1a in which correction parameter value ΔAc is not updated during exposure
   3.1 Operation
      3.1.1 Main flow
      3.1.2 Burst oscillation
   3.2 Effect
4. Laser device 1a in which second adjustment oscillation is performed
   4.1 Operation
      4.1.1 Acquisition of data set of correction parameter value ΔAc
      4.1.2 Second adjustment oscillation
   4.2 Effect
5. Laser device 1a in which pulse energy E, wavelength λ, and spectral line width Δλ are synchronously controlled
6. Laser device 1c that receives set voltage value HV from exposure apparatus 100
   6.1 Configuration
   6.2 Operation
      6.2.1 Main flow
      6.2.2 Burst oscillation and update of correction parameter value ΔAc
         6.2.2.1 Calculation of corrected operation parameter value Ac(k)
         6.2.2.2 Calculation of correction parameter value ΔAc(k) for next burst
   6.3 Effect
7. Laser device 1c in which correction parameter value ΔAc is not updated during exposure
8. Laser device 1d in which spectral line width DA is adjusted depending on discharge timings of laser oscillator 17 and laser amplifier PO
   8.1 Configuration
   8.2 Operation
9. Laser device 1e including solid state laser
   9.1 Configuration
      9.1.1 Laser oscillator 18
      9.1.2 Laser amplifier PA
   9.2 Operation
10. Exposure apparatus 100a that corrects operation parameter value A
   10.1 Configuration
   10.2 Operation
   10.3 Effect
11. Others

Hereinafter, embodiments of the present disclosure will be described in detail with reference to the drawings. The embodiments described below show some examples of the present disclosure and do not limit the contents of the present disclosure. Also, all configurations and operation described in the embodiments are not necessarily essential as configurations and operation of the present disclosure. Here, the same components are denoted by the same reference numeral, and duplicate description thereof is omitted.

### 1. Comparative Example

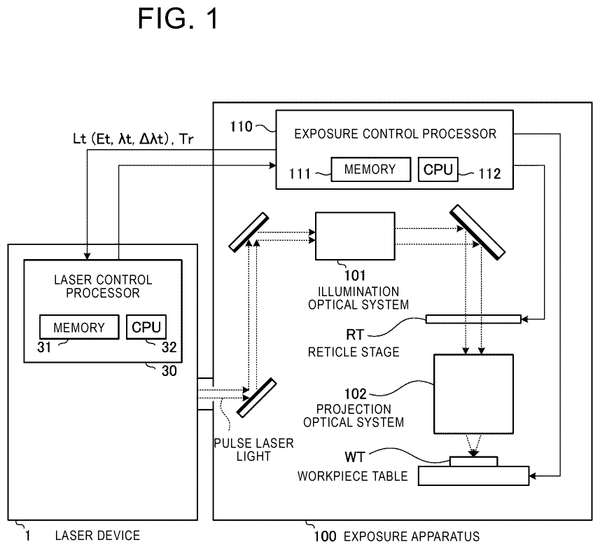

FIG. 1 schematically shows the configuration of an exposure system of a comparative example. The comparative example of the present disclosure is an example recognized by the applicant as known only by the applicant, and is not a publicly known example admitted by the applicant. The exposure system includes a laser device 1 and an exposure apparatus 100. The laser device 1 includes a laser control processor 30. The laser control processor 30 is a processing device including a memory 31 in which a control program is stored, and a central processing unit (CPU) 32 which executes the control program. The laser control processor 30 is specifically configured or programmed to perform various processes included in the present disclosure. The laser device 1 is configured to output pulse laser light toward the exposure apparatus 100.

1.1 Configuration of exposure apparatus 100

The exposure apparatus 100 includes an illumination optical system 101, a projection optical system 102, and an exposure control processor 110. The illumination optical system 101 illuminates a reticle pattern of a reticle (not shown) arranged on a reticle stage RT with the pulse laser light incident from the laser device 1. The projection optical system 102 causes the pulse laser light transmitted through the reticle to be imaged as being reduced and projected on a workpiece (not shown) arranged on a workpiece table WT. The workpiece is a photosensitive substrate such as a semiconductor wafer on which a resist film is applied.

The exposure control processor 110 is a processing device including a memory 111 in which the control program is stored, and a CPU 112 which executes the control program. The exposure control processor 110 is specifically configured or programmed to perform various processes included in the present disclosure. The exposure control processor 110 performs overall control of the exposure apparatus 100 and transmits and receives various data and various signals to and from the laser control processor 30.

### 1.2 Operation of Exposure Apparatus 100

The exposure control processor 110 transmits a target value Lt of a laser light parameter L and a trigger signal Tr to the laser control processor 30. The laser light parameter L includes a pulse energy E, a wavelength λ, and a spectral line width Δλ, and the target value Lt includes target values Et, λt, Δλt thereof. The laser control processor 30 controls the laser device 1 in accordance with these data and signal. The exposure control processor 110 synchronously translates the reticle stage RT and the workpiece table WT in opposite directions to each other. Thus, the workpiece is exposed to the pulse laser light reflecting the reticle pattern.

By such an exposure process, the reticle pattern is transferred onto the semiconductor wafer. Thereafter, an electronic device can be manufactured through a plurality of processes.

### 1.3 Configuration of Laser Device 1

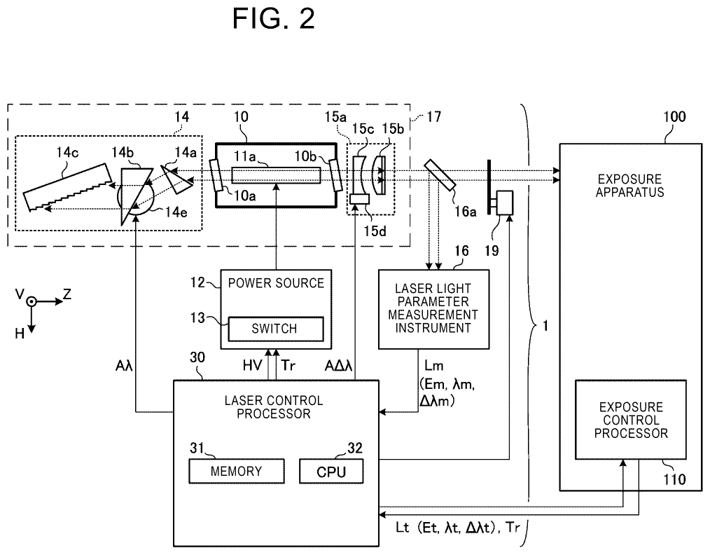

FIG. 2 schematically shows the configuration of the laser device 1 according to the comparative example. The laser device 1 includes a laser oscillator 17, a power source 12, a laser light parameter measurement instrument 16, a shutter 19, and a laser control processor 30. The laser device 1 is connectable to the exposure apparatus 100. In FIG. 2, a Z axis, a V axis, and an H axis perpendicular to one another are shown. The pulse laser light is output from the laser oscillator 17 in the Z direction.

The laser oscillator 17 includes a laser chamber 10, a discharge electrode 11a, a line narrowing module 14, and a spectrum adjuster 15a. The line narrowing module 14 and the spectrum adjuster 15a configure a laser resonator. The laser chamber 10 is arranged on the optical path of the laser resonator. Windows 10a, 10b are arranged at both ends of the laser chamber 10. The discharge electrode 11a and a discharge electrode (not shown) paired with the discharge electrode 11a are arranged inside the laser chamber 10. The discharge electrode (not shown) is positioned so as to overlap with the discharge electrode 11a in the V-axis direction perpendicular to the paper surface. The laser chamber 10 is filled with a laser gas containing, for example, an argon gas or a krypton gas as a rare gas, a fluorine gas as a halogen gas, a neon gas as a buffer gas, and the like.

The power source 12 includes a switch 13 and is connected to the discharge electrode 11a and a charger (not shown). The power source 12 is an example of the actuator in the present disclosure.

The line narrowing module 14 includes a plurality of prisms 14a, 14b and a grating 14c. The prisms 14a, 14b are arranged in this order on the optical path of the light output from the window 10a. The surfaces of the prisms 14a, 14b on and from which the light is incident and exits are both parallel to the V direction. The grating 14c is arranged on the optical path of the light transmitted through the prisms 14a, 14b in the Littrow arrangement so that the incident angle and the diffraction angle coincide with each other. The direction of grooves of the grating 14c is parallel to the V direction.

The prism 14b is supported by a rotation stage 14e. The rotation stage 14e includes a driver (not shown). The rotation stage 14e is an example of the actuator in the present disclosure.

The spectrum adjuster 15a includes a cylindrical plano-convex lens 15b, a cylindrical plano-concave lens 15c, and a linear stage 15d. The cylindrical plano-concave lens 15c is arranged between the laser chamber 10 and the cylindrical plano-convex lens 15b. The cylindrical plano-convex lens 15b and the cylindrical plano-concave lens 15c are arranged such that the convex surface of the cylindrical plano-convex lens 15b and the concave surface of the cylindrical plano-concave lens 15c face each other. The convex surface of the cylindrical plano-convex lens 15b and the concave surface of the cylindrical plano-concave lens 15c each have a focal axis parallel to the V direction. The planar surface of the cylindrical plano-convex lens 15b opposite to the convex surface is coated with a partial reflection film.

The cylindrical plano-concave lens 15c is supported by the linear stage 15d. The linear stage 15d includes a driver (not shown). The linear stage 15d is an example of the actuator in the present disclosure.

A beam splitter 16a is arranged on the optical path of the pulse laser light output from the spectrum adjuster 15a. The beam splitter 16a is configured to transmit a part of the pulse laser light toward the exposure apparatus 100 at a high transmittance and to reflect the other part thereof. The laser light parameter measurement instrument 16 is arranged on the optical path of the pulse laser light reflected by the beam splitter 16a. The laser light parameter measurement instrument 16 outputs a measurement value Lm of the laser light parameter L. The measurement value Lm includes measurement values Em, λm, Δλm of the pulse energy E, the wavelength λ, and the spectral line width Δλ.

For example, the laser light parameter measurement instrument 16 includes an energy monitor (not shown) and a spectrum monitor (not shown). The energy monitor includes a photodiode (not shown) and outputs a signal including the measurement value Em of the pulse energy E of the pulse laser light. The spectrum monitor includes an etalon spectrometer (not shown) and outputs waveform data of interference fringes of the pulse laser light. A processing device (not shown) included in the laser light parameter measurement instrument 16 calculates the measurement values λm, Δλm of the wavelength λ and the spectral line width Δλ of the pulse laser light from the waveform data of the interference fringes. The wavelength λ of the pulse laser light means the center wavelength.

The shutter 19 is located on the optical path of the pulse laser light transmitted through the beam splitter 16a. The shutter 19 is configured to be capable of switching between passage and blocking of the pulse laser light to the exposure apparatus 100.

### 1.4 Operation of Laser Device 1

The laser control processor 30 receives the data of the target value Lt of the laser light parameter L and the trigger signal Tr from the exposure control processor 110, and outputs an operation parameter value A of the actuator based on the target value Lt. The operation parameter value A includes a set voltage value HV for adjusting the pulse energy E, a set value Aλ of the rotation angle of the prism 14b for adjusting the wavelength λ, and a set value AΔλ of the position of the cylindrical plano-concave lens 15c for adjusting the spectral line width Δλ. That is, the laser control processor 30 transmits, to the power source 12, the set voltage value HV for the voltage to be applied to the discharge electrode 11a based on the target value Et of the pulse energy E. The laser control processor 30 transmits, to the rotation stage 14e, the set value Aλ of the rotation angle of the prism 14b based on the target value λt of the wavelength λ. The laser control processor 30 transmits, to the linear stage 15d, the set value AΔλ of the position of the cylindrical plano-concave lens 15c based on the target value Δλt of the spectral line width Δλ. Further, the laser control processor 30 transmits the trigger signal Tr to the power source 12.

The switch 13 is turned on when the power source 12 receives the trigger signal Tr. When the switch 13 is turned on, the power source 12 generates a pulse high voltage corresponding to the set voltage value HV from the electric energy charged in the charger (not shown), and applies the high voltage to the discharge electrode 11a.

When the high voltage is applied to the discharge electrode 11a, discharge occurs in the laser chamber 10. The laser medium in the laser chamber 10 is excited by the energy of the discharge and shifts to a high energy level. When the excited laser medium then shifts to a low energy level, light having a wavelength corresponding to the difference between the energy levels is emitted.

The light generated in the laser chamber 10 is output to the outside of the laser chamber 10 through the windows 10a, 10b. The beam width in the H direction of the light output through the window 10a of the laser chamber 10 is expanded by the prisms 14a, 14b, and then the light is incident on the grating 14c. The light incident on the grating 14c from the prisms 14a, 14b is reflected by the plurality of grooves of the grating 14c and is diffracted in a direction corresponding to the wavelength of the light. By matching the incident angle of the light incident on the grating 14c with the diffraction angle of the diffracted light having a desired wavelength, the wavelength of the diffracted light incident on the prism 14b from the grating 14c is selected. The prisms 14a, 14b reduce the beam width in the H direction of the diffracted light incident thereon from the grating 14c and returns the light to the laser chamber 10 through the window 10a.

The cylindrical plano-convex lens 15b included in the spectrum adjuster 15a transmits and outputs a part of the light output from the window 10b of the laser chamber 10, and reflects the other part back into the laser chamber 10 through the window 10b.

In this way, the light output from the laser chamber 10 reciprocates between the line narrowing module 14 and the spectrum adjuster 15a, and is amplified each time the light passes through a discharge space in the laser chamber 10. The light is line narrowed each time being turned back in the line narrowing module 14. Thus, the light having undergone laser oscillation and line narrowing is output as the pulse laser light from the spectrum adjuster 15a.

The rotation stage 14e included in the line narrowing module 14 rotates the prism 14b about an axis parallel to the V direction in accordance with the set value Aλ output from the laser control processor 30. Thus, the wavelength selected by the line narrowing module 14 is adjusted, and the wavelength λ of the pulse laser light is adjusted. The wavelength λ of the pulse laser light is not limited to being adjusted by rotating the prism 14b, and may be adjusted by arranging a mirror (not shown) in the line narrowing module 14, changing the posture of the mirror, and adjusting the incident angle of the light incident on the grating 14c.

The linear stage 15d included in the spectrum adjuster 15a moves the cylindrical plano-concave lens 15c along the optical path between the laser chamber 10 and the cylindrical plano-convex lens 15b in accordance with the set value AΔλ output from the laser control processor 30. Thus, the wavefront of the light traveling from the spectrum adjuster 15a toward the line narrowing module 14 is adjusted, and the spectral line width Δλ of the pulse laser light is adjusted.

The laser light parameter measurement instrument 16 outputs the measurement value Lm of the laser light parameter L of the pulse laser light to the laser control processor 30. The measurement value Em of the pulse energy E included in the measurement value Lm is used by the laser control processor 30 to perform feedback control of the set voltage value HV. The measurement value λm of the wavelength λ included in the measurement value Lm is used by the laser control processor 30 to perform feedback control of the set value Aλ of the rotation angle of the prism 14b. The measurement value Δλm of the spectral line width Δλ included in the measurement value Lm is used by the laser control processor 30 to perform feedback control of the set value AΔλ of the position of the cylindrical plano-concave lens 15c.

### 1.5 Step-and-Scan Exposure

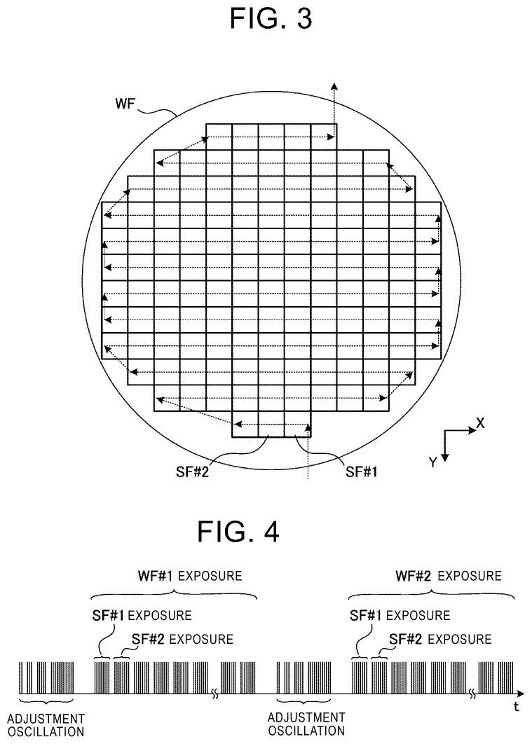

FIG. 3 shows an example of a semiconductor wafer WF exposed by the exposure system. In FIG. 3, an X axis and a Y axis perpendicular to each other in the surface of the semiconductor wafer WF are shown. The semiconductor wafer WF is, for example, a single crystal silicon plate having a substantially disk shape. For example, a photosensitive resist film is applied to the semiconductor wafer WF. Exposure of the semiconductor wafer WF is performed for each section such as a scan field SF #1, SF #2, or the like. Each of the scan fields SF #1, SF #2 corresponds to an area where a reticle pattern of one reticle is transferred. Here, #1 and #2 indicate the exposure order. When explaining without specifying the exposure order, #1, #2, and the like may not be added. The semiconductor wafer WF is moved so that the first scan field SF #1 is irradiated with the pulse laser light, and exposure of the scan field SF #1 is performed. Thereafter, the semiconductor wafer WF is moved so that the second scan field SF #2 is irradiated with the pulse laser light, and exposure of the scan field SF #2 is performed. Thereafter, the wafer WF is moved in a similar manner to perform exposure of all scan fields SF.

FIG. 4 shows an example of the trigger signal Tr transmitted to the power source 12. When one scan field SF is to be exposed, the pulse laser light is continuously output at a predetermined repetition frequency. When moving from one scan field SF to another scan field SF, the output of the pulse laser light is paused. The operation of continuously outputting the pulse laser light is referred to as a burst. The burst is repeated a plurality of times to perform exposure of one semiconductor wafer WF. Such laser oscillation is called burst oscillation.

When exposure of a first semiconductor wafer WF #1 is completed, output of the pulse laser light to the exposure apparatus 100 is stopped to replace the semiconductor wafer WF #1 on the workpiece table WT with a second semiconductor wafer WF #2. In a state in which the shutter 19 is closed, adjustment oscillation for the purpose of adjusting parameters or the like may be performed.

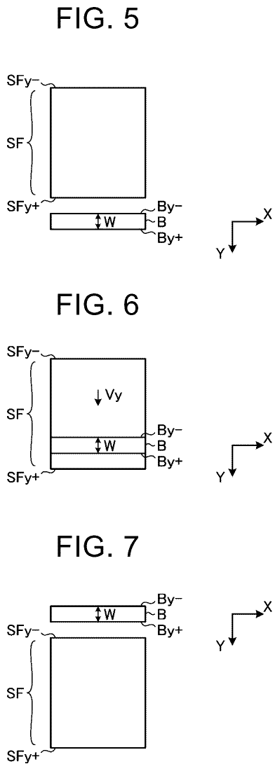

FIGS. 5 to 7 show how the position of the scan field SF changes with respect to the position of the pulse laser light. The width of the scan field SF in the X-axis direction is the same as the width of a beam cross section B of the pulse laser light in the X-axis direction at the position of the workpiece table WT. The width of the scan field SF in the Y-axis direction is larger than the width W of the beam cross section B of the pulse laser light in the Y-axis direction at the position of the workpiece table WT.

The procedure of exposing the scan field SF with the pulse laser light is performed in the order of FIGS. 5, 6, and 7. First, as shown in FIG. 5, the workpiece table WT is positioned so that the position of an end SFy+ of the scan field SF in the +Y direction is spaced apart by a predetermined distance in the −Y direction with respect to the position of an end By− of the beam cross section B in the −Y direction. Then, the workpiece table WT is accelerated in the +Y direction. The velocity of the workpiece table WT becomes Vy by the time when the end SFy+ of the scan field SF in the +Y direction coincides with the position of the end By− of the beam cross section B in the −Y direction. As shown in FIG. 6, exposure of the scan field SF is performed while the workpiece table WT is moved such that the position of the scan field SF performs constant velocity linear motion at the velocity Vy with respect to the position of the beam cross section B. As shown in FIG. 7, when the workpiece table WT is moved until the position of the end By+ of the beam cross section B in the +Y direction passes the end SFy− of the scan field SF in the −Y direction, the exposure of the scan field SF is completed. In this way, the exposure is performed while the scan field SF moves with respect to the position of the beam cross section B.

The required time T for the scan field SF to move by the distance corresponding to the width W of the beam cross section B of the pulse laser light at the velocity Vy is obtained as follows.

T=W/Vy

The number of irradiation pulses Ns of the pulse laser light radiated to any one location of the scan field SF is the same as the number of pulses of the pulse laser light generated in the required time T as follows.

Ns=f·T

Here, f is the repetition frequency of the pulse laser light.

The number of irradiation pulses Ns is also referred to as an N slit pulse number. The exposure quality in the plane of the scan field SF is constant by setting the number of irradiation pulses Ns to be constant at any position in the scan field SF.

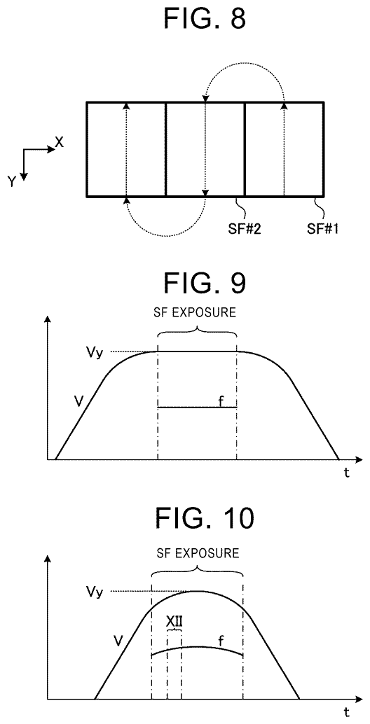

FIG. 8 shows a procedure of sequentially exposing the plurality of scan fields SF #1, SF #2, and the like. In the step-and-scan exposure, the scanning direction switches from the Y direction to the −Y direction or from the −Y direction to the Y direction every time moving from the scan field SF #1 to the next scan field SF #2. Therefore, it is not possible to move from one scan field SF #1 to the next scan field SF #2 while maintaining constant velocity linear motion at the velocity Vy, and the velocity component of the workpiece table WT in the Y direction must be decelerated to zero and accelerated in the opposite direction.

FIG. 9 is a graph showing changes in the velocity V of the workpiece table WT and the repetition frequency f when the scan field SF is exposed in the comparative example. The scan field SF is exposed by the pulse laser light having the repetition frequency f while the workpiece table WT performs constant velocity linear motion at the velocity Vy so that the number of irradiation pulses Ns becomes constant at any position in the scan field SF. It is necessary to accelerate from velocity 0 before the exposure, and to decelerate to velocity 0 after the exposure. In the comparative example, exposure cannot be performed during the acceleration/deceleration period, which may hinder improvement in the production efficiency.

FIG. 10 is a graph showing changes in the velocity V of the workpiece table WT and the repetition frequency f during on-acceleration exposure. As an exposure technology different from the comparative example, it has been proposed to start exposure of the scan field SF before the workpiece table WT reaches constant velocity linear motion, and to end exposure of the scan field SF after the workpiece table WT starts decelerating. This exposure technology is referred to as on-acceleration exposure. On-acceleration in the on-acceleration exposure refers to a state in which the acceleration is other than 0, and includes on-deceleration. In the comparative example shown in FIG. 9, the repetition frequency f of the pulse laser light during exposure has a constant value, whereas in on-acceleration exposure, the repetition frequency f is changed, in accordance with the change in the velocity V of the workpiece table WT, during exposure so that the number of irradiation pulses Ns is constant at any position in the scan field SF.

In on-acceleration exposure, exposure is started before the workpiece table WT reaches the velocity Vy, so that the time required from the start of exposure to the end of exposure of one scan field SF is slightly longer than that in the comparative example. However, the time required for acceleration from velocity 0 to the start of exposure and the time required for deceleration from the end of exposure to velocity 0 are shorter than those in the comparative example, so that the overall production efficiency can be improved.

1.6 Problem Associated with Change in Repetition Frequency f

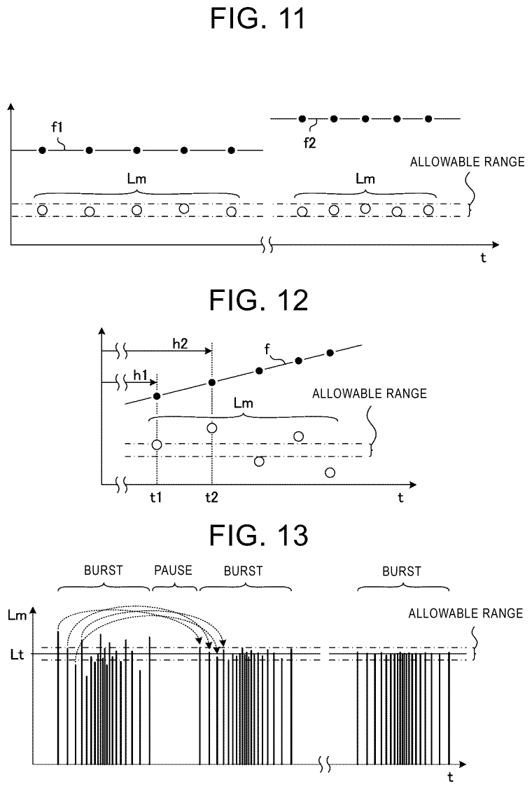

FIG. 11 is a graph showing changes in the repetition frequency f and the measurement value Lm of the laser light parameter L in the comparative example. When the repetition frequency f changes, the measurement value Lm of the laser light parameter L may change owing to that the influence of an acoustic wave generated inside the laser chamber 10 changes, the influence of thermal loads applied to various optical elements changes, or other factors. However, even when the repetition frequency f changes, if the output of the pulse laser light at the same repetition frequency f is continuous as in the comparative example, by performing a correction in accordance with the repetition frequency f in addition to the feedback control of the laser light parameter L, it is possible to keep the measurement value Lm within an allowable range. For example, a first correction may be performed at a first repetition frequency f1, and a second correction may be performed at a second repetition frequency f2.

FIG. 12 is a graph showing changes in the repetition frequency f that changes continuously and the measurement value Lm of the laser light parameter L. The change in the repetition frequency f shown in FIG. 12 corresponds to the change in the repetition frequency f within a period indicated by XII in FIG. 10. When the pulse laser light is output while the repetition frequency f is continuously changed, it may be difficult to keep the measurement value Lm within the allowable range even if corrections in accordance with the repetition frequency f are performed in addition to the feedback control for each pulse. For example, even if the same correction is performed in a case in which the first repetition frequency f1 is reached while the repetition frequency f is increased and in a case in which the first repetition frequency f1 is reached while the repetition frequency f is decreased, the measurement value Lm does not become the same. The reason for this is presumed to be that, even when the repetition frequency f is the same, the density distribution and the temperature distribution of a gas in the laser chamber 10 and the temperature of optical elements are different depending on the history of the change in the repetition frequency f.

A history h1 of the change in the repetition frequency f up to time t1 in FIG. 12 is different from a history h2 of the change in the repetition frequency f up to time t2. Since the influence of such a history is considered to be different for each pulse, in the control of the laser light parameter L in a case of continuously changing the repetition frequency f, different corrections may be required according to the history.

The object of the present disclosure is to provide a laser device that stabilizes the measurement value Lm of the laser light parameter L to a value close to the target value Lt when the repetition frequency f is continuously changed, and a control method thereof.

### 2. Laser Device 1a Using Correction Parameter Value ΔAc for Each Burst Oscillation Pulse

### 2.1 Concept

FIG. 13 is a graph showing the measurement value Lm of the laser light parameter L in a first embodiment. The repetition frequency f is the smallest immediately after the start and immediately before the end of one burst, and in the middle of the burst, the repetition frequency f gradually increases and then gradually decreases. When the change pattern of the repetition frequency f is the same for a first burst and a second burst, the history of the change in the repetition frequency f for the pulses in the first burst is the same as that for the pulses in the second burst having the same output order.

Therefore, a correction parameter value ΔAc of each pulse is calculated based on a difference between the measurement value Lm and the target value Lt of each pulse in the first burst, and the laser light parameter L of each pulse whose output order is the same in the second burst is controlled using the correction parameter value ΔAc. Accordingly, the measurement value Lm of each pulse in the second burst may be closer to the target value Lt than the measurement value Lm of each pulse in the first burst. Further, by updating the correction parameter value ΔAc while repeating the burst, the accuracy of the correction parameter value ΔAc can be improved. The correction parameter value ΔAc includes any one of a correction parameter value ΔHVc for correcting the set voltage value HV, a correction parameter value ΔAλc for correcting the set angle value Aλ of the rotation angle of the prism 14b, and a correction parameter value ΔAΔλc for correcting the set value AΔλ of the position of the cylindrical plano-concave lens 15c.

### 2.2 Configuration

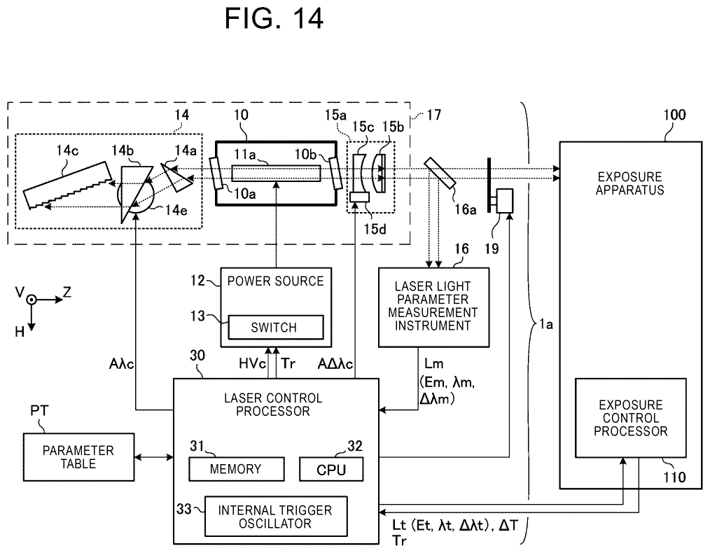

FIG. 14 schematically shows the configuration of a laser device 1a according to the first embodiment. In the laser device 1a, the laser control processor 30 includes an internal trigger oscillator 33. The internal trigger oscillator 33 is configured to be capable of generating the trigger signal Tr and transmitting it to the power source 12 without receiving the trigger signal Tr from the exposure control processor 110 when performing adjustment oscillation to be described later.

The exposure control processor 110 transmits time-series data of a pulse time interval ΔT to the laser control processor 30. The time-series data of the pulse time interval ΔT will be described later with reference to FIG. 18.

The laser control processor 30 is configured to be accessible to a parameter table PT. The parameter table PT stores the correction parameter value ΔAc of each pulse in the burst. The parameter table PT corresponds to the table in the present disclosure. The parameter table PT will be further described later with reference to FIG. 25.

The laser control processor 30 corrects the operation parameter value A calculated based on the target value Lt using the correction parameter value ΔAc, and transmits a corrected operation parameter value Ac to the corresponding actuator. The corrected operation parameter value Ac includes any one of a corrected set voltage value HVc, a corrected set value ΔAc of the rotation angle of the prism 14b, and a corrected set value AΔλc of the position of the cylindrical plano-concave lens 15c.

### 2.3 Operation

### 2.3.1 Main Flow

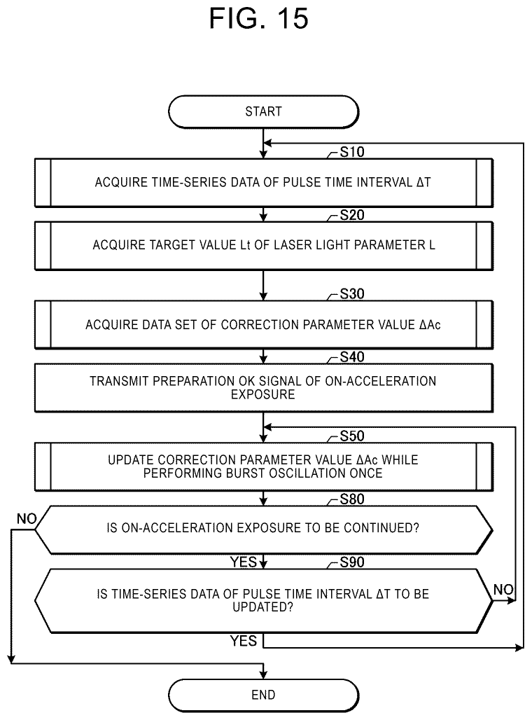

FIG. 15 is a flowchart of laser control in the first embodiment. The laser control processor 30 updates, by the following processing, the correction parameter value ΔAc for the next burst while performing burst oscillation using the correction parameter value ΔAc.

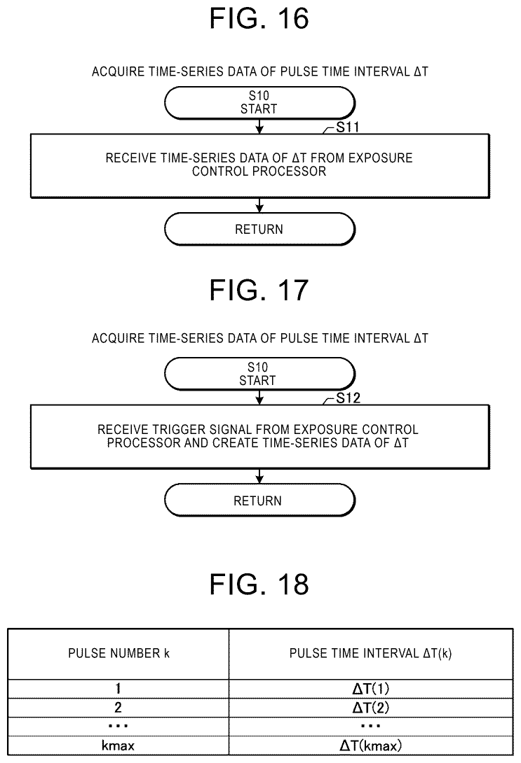

In S10, the laser control processor 30 acquires the time-series data of the pulse time interval ΔT. Details of S10 will be described later with reference to FIGS. 16 to 18.

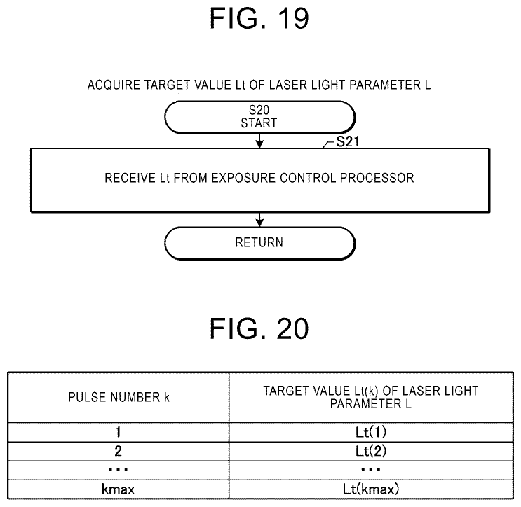

In S20, the laser control processor 30 acquires the target value Lt of the laser light parameter L. Details of S20 will be described later with reference to FIGS. 19 and 20.

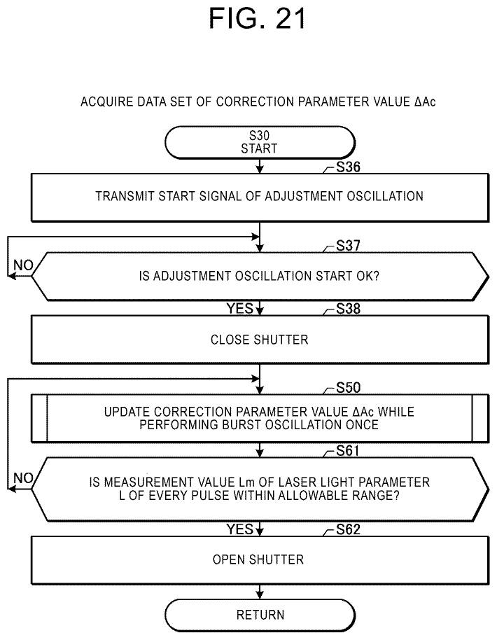

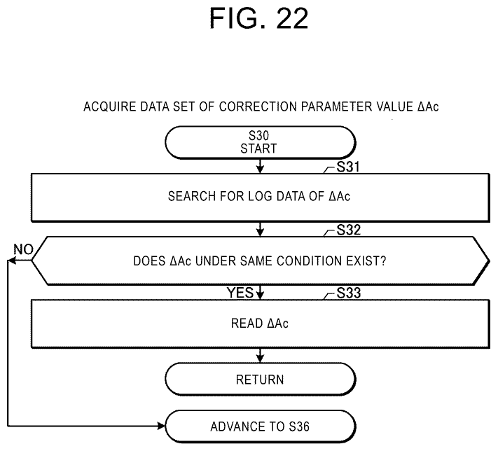

In S30, the laser control processor 30 acquires a data set of the correction parameter value ΔAc. Details of S30 will be described later with reference to FIGS. 21 and 22.

In S40, the laser control processor 30 transmits a preparation OK signal for on-acceleration exposure to the exposure control processor 110. Upon receiving the preparation OK signal, the exposure control processor 110 prepares for operation of the workpiece table WT and the like, and then transmits various data and the trigger signal Tr to the laser control processor 30.

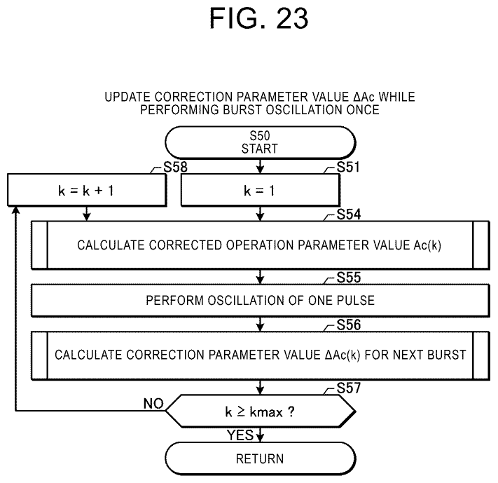

In S50, the laser control processor 30 updates the correction parameter value ΔAc for the next burst while performing burst oscillation once using the correction parameter value ΔAc. Details of S50 will be described later with reference to FIGS. 23 to 30.

In S80, the laser control processor 30 determines whether or not to continue on-acceleration exposure. For example, when the exposure apparatus 100 stops on-acceleration exposure and performs exposure with constant velocity linear motion, it is determined that on-acceleration exposure is not to be continued. When on-acceleration exposure is not to be continued (S80:NO), the laser control processor 30 ends processing of the present flowchart. When on-acceleration exposure is to be continued (S80:YES), the laser control processor 30 advances processing to S90.

In S90, the laser control processor 30 determines whether or not to update the time-series data of the pulse time interval ΔT. When the exposure apparatus 100 changes the change pattern of the pulse time interval ΔT, it is determined to update the time-series data of the pulse time interval ΔT. When the time-series data of the pulse time interval ΔT is to be updated (S90:YES), the laser control processor 30 returns processing to S10 to re-acquire the appropriate correction parameter value ΔAc. When the time-series data of the pulse time interval ΔT is not to be updated (S90:NO), the laser control processor 30 returns processing to S50.

### 2.3.2 Acquisition of Time-Series Data of Pulse Time Interval ΔT

FIG. 16 is a flowchart showing a first example of processing of acquiring the time-series data of the pulse time interval ΔT. FIG. 16 corresponds to a subroutine of S10 of FIG. 15. In 511, the laser control processor 30 acquires the time-series data of the pulse time interval ΔT by receiving the time-series data from the exposure control processor 110. After 511, the laser control processor 30 ends processing of the present flowchart and returns to processing shown in FIG. 15.

FIG. 17 is a flowchart showing a second example of processing of acquiring the time-series data of the pulse time interval ΔT. FIG. 17 corresponds to a subroutine of S10 of FIG. 15. In S12, the laser control processor 30 receives the trigger signal Tr from the exposure control processor 110 and measures a time interval of the trigger signal Tr to acquire the time-series data of the pulse time interval ΔT. After S12, the laser control processor 30 ends processing of the present flowchart and returns to processing shown in FIG. 15. The trigger signal Tr received in S12 may be the trigger signal Tr generated during exposure in the exposure apparatus 100, or may be a dummy trigger signal Tr generated when exposure is not performed.

FIG. 18 shows an example of the time-series data of the pulse time interval ΔT. Let kmax be the number of pulses included in one burst. As a pulse number k in the burst, integral values from 1 to kmax are given sequentially in accordance with the output order of the pulse. The pulse time interval ΔT is given as a time difference from the previous pulse for each pulse number k. The pulse time interval ΔT for a particular pulse number k is expressed as a pulse time interval ΔT(k). For example, a pulse time interval ΔT(2) is a time interval from the output time of the pulse having a pulse number 1 to the output time of the pulse having a pulse number 2. A pulse time interval ΔT(1) may be, for example, the length of a pause period before the burst starts. Alternatively, the pulse time interval ΔT(1) may be blank. Instead of the pulse time interval ΔT(k), the time-series data of the repetition frequency f which is an inverse of the pulse time interval ΔT(k) may be acquired.

### 2.3.3 Acquisition of Target Value Lt of Laser Light Parameter L

FIG. 19 is a flowchart showing an example of processing of acquiring the target value Lt of the laser light parameter L. FIG. 19 corresponds to a subroutine of S20 of FIG. 15. In S21, the laser control processor 30 acquires the target value Lt by receiving it from the exposure control processor 110. After S21, the laser control processor 30 ends processing of the present flowchart and returns to processing shown in FIG. 15.

FIG. 20 shows an example of the target value Lt of the laser light parameter L. The target value Lt may be set for each pulse number k and stored in association with the pulse number k. The target value Lt for a particular pulse number k is expressed as a target value Lt(k). Target values Lt(1) to Lt(kmax) may all be the same value.

### 2.3.4 Acquisition of Data Set of Correction Parameter Value ΔAc

FIG. 21 is a flowchart showing a first example of processing of acquiring the data set of the correction parameter value ΔAc. FIG. 21 corresponds to a subroutine of S30 of FIG. 15. In the first example, the laser device 1a performs adjustment oscillation when exposure is not performed in the exposure apparatus 100, and the data set of the correction parameter value ΔAc is acquired.

In S36, the laser control processor 30 transmits a start signal of adjustment oscillation to the exposure control processor 110. The exposure control processor 110 transmits a start OK signal to the laser control processor 30 when adjustment oscillation can be started in the laser device 1a.

In S37, the laser control processor 30 determines whether or not the start OK signal for adjustment oscillation has been received. When the start OK signal has not been received (S37:NO), the laser control processor 30 waits until the start OK signal is received. When the start OK signal has been received (S37:YES), the laser control processor 30 advances processing to S38.

In S38, the laser control processor 30 closes the shutter 19. Alternatively, when another shutter is provided in the exposure apparatus 100 and is to be closed before the exposure control processor 110 outputs the start OK signal, opening and closing of the shutter 19 may not be performed.

In S50, the laser control processor 30 updates the correction parameter value ΔAc for the next burst while performing burst oscillation once using the correction parameter value ΔAc. The process of S50 is the same as the process of S50 included in FIG. 15. However, although burst oscillation is performed upon receiving the trigger signal Tr from the exposure control processor 110 in FIG. 15, in FIG. 21, the internal trigger oscillator 33 may generate the trigger signal Tr to perform burst oscillation. Further, in FIG. 21, all correction parameter values ΔAc read when burst oscillation is performed for the first time may be 0. Burst oscillation performed in S50 of FIG. 21 corresponds to the first adjustment oscillation in the present disclosure. Details of S50 will be described later with reference to FIGS. 23 to 30.

In S61, the laser control processor 30 determines whether or not the measurement value Lm of the laser light parameter L of every pulse in the burst is within the allowable range. When the measurement value Lm of one or more pulses in the burst is out of the allowable range (S61:NO), the laser control processor 30 returns processing to S50. The process of S50 may be performed a plurality of times until the measurement value Lm of every pulse in the burst is within the allowable range. When the measurement value Lm of every pulse in the burst is within the allowable range (S61:YES), the laser control processor 30 advances processing to S62. In addition to determining whether or not the measurement value Lm of each pulse is within the allowable range, the variation of the measurement values Lm may be evaluated by an index such as a standard deviation to further determine whether or not the variation is within an allowable range.

In S62, the laser control processor 30 opens the shutter 19. After S62, the laser control processor 30 ends processing of the present flowchart and returns to processing shown in FIG. 15.

FIG. 22 is a flowchart showing a second example of processing of acquiring the data set of the correction parameter value ΔAc. FIG. 22 corresponds to a subroutine of S30 of FIG. 15. In the second example, the correction parameter value ΔAc is acquired from past log data (not shown) of the correction parameter value ΔAc. The log data may be, for example, data in which the parameter table PT as shown in FIG. 25 is stored for each of a plurality of change patterns of the pulse time interval ΔT.

In S31, the laser control processor 30 searches for the log data of the correction parameter value ΔAc. As a search key, the time-series data of the pulse time interval ΔT, data of the target value Lt of the laser light parameter L, and data of another exposure condition are used.

In S32, the laser control processor 30 determines whether or not a data set of the correction parameter value ΔAc that matches the search key exists. If a data set of the correction parameter value ΔAc that matches the search key exists (S32:YES), the laser control processor 30 advances processing to S33. If a data set of the correction parameter value ΔAc that matches the search key does not exist (S32:NO), the laser control processor 30 advances processing to S36 of FIG. 21, and then performs adjustment oscillation to acquire a data set of the correction parameter value ΔAc.

In S33, the laser control processor 30 reads the data set of the correction parameter value ΔAc that matches the search key in the log data. After S33, the laser control processor 30 ends processing of the present flowchart and returns to processing shown in FIG. 15. The data set of the correction parameter value ΔAc read in S33 may be used to control the pulse laser light for performing on-acceleration exposure.

Alternatively, after S33, the laser control processor 30 may advance processing to S36 of FIG. 21 and use the correction parameter value ΔAc read in S33 as an initial value of the correction parameter value ΔAc in the adjustment oscillation. In this case, since the measurement value Lm of the laser light parameter L can be within the allowable range at an early stage, the number of bursts in adjustment oscillation can be reduced, and the reliability of the correction parameter value ΔAc can be further improved.

### 2.3.5 Burst Oscillation and Update of Correction Parameter Value ΔAc

FIG. 23 is a flowchart showing an example of processing of updating the correction parameter value ΔAc while performing burst oscillation once. FIG. 23 shows common processing corresponding to a subroutine of S50 of FIG. 15 and also corresponding to a subroutine of S50 of FIG. 21. In S50 of FIG. 15, on-acceleration exposure is performed after S40, whereas in S50 of FIG. 21, adjustment oscillation is performed after S38.

In S51, the laser control processor 30 sets the value of the pulse number k to 1. Description will be given by adding (k) to the end of a symbol indicating a value of each of various kinds in a case in which the pulse number k is specified.

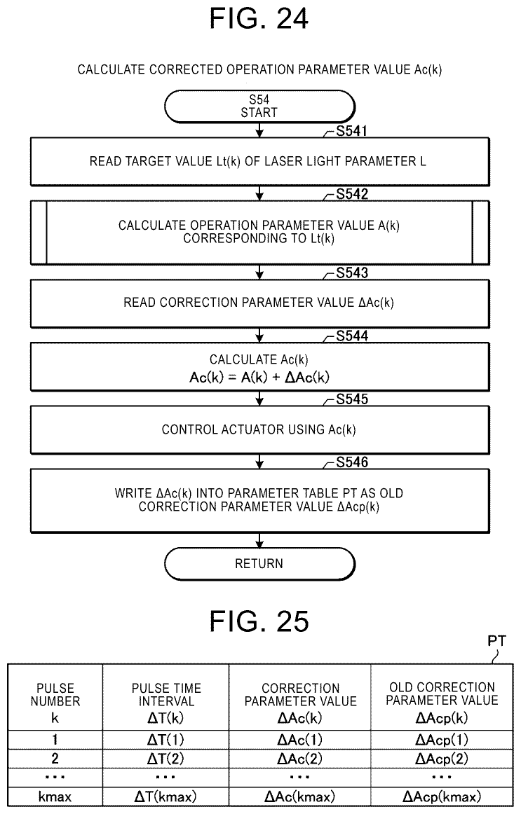

In S54, the laser control processor 30 calculates a corrected operation parameter value Ac(k) by correcting, using a correction parameter value ΔAc(k), an operation parameter value A(k) calculated based on the target value Lt(k). Details of S54 will be described later with reference to FIGS. 24 to 27.

In S55, the laser control processor 30 performs laser oscillation of one pulse to generate the pulse laser light. When processing of FIG. 23 is performed as a subroutine of S50 of FIG. 15, the generated pulse laser light is output to the exposure apparatus 100. When processing of FIG. 23 is performed as a subroutine of S50 of FIG. 21, the generated pulse laser light may not be output to the exposure apparatus 100.

The process of S55 is performed at a timing in accordance with a pulse time interval ΔT(k). That is, the time difference between the pulse laser light of the pulse number k−1 and the pulse laser light of the pulse number k is the pulse time interval ΔT(k). The change pattern of the pulse time interval ΔT is the same between when processing of FIG. 23 is performed as a subroutine of S50 of FIG. 15 and when that is performed as a subroutine of S50 of FIG. 21. Therefore, the correction parameter value ΔAc(k) acquired based on the change pattern of the pulse time interval ΔT in S50 of FIG. 21 can be used to correct the operation parameter value A(k) in S50 of FIG. 15.

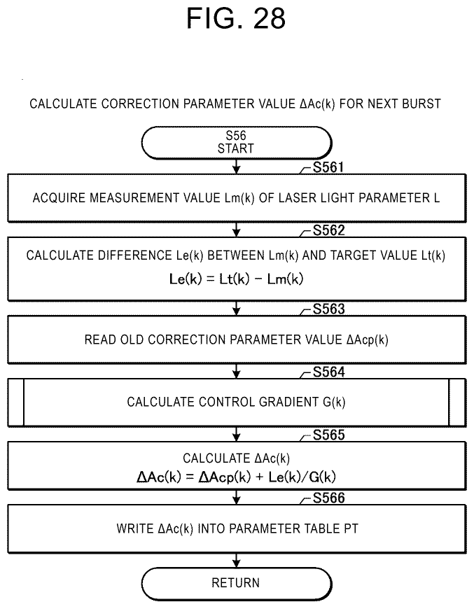

In S56, the laser control processor 30 calculates the correction parameter value ΔAc(k) for the next burst so that the difference between a measurement value Lm(k) and the target value Lt(k) of the laser light parameter L becomes small in the next burst. Details of S56 will be described later with reference to FIGS. 28 to 30.

In S57, the laser control processor 30 determines whether or not the value of the pulse number k has reached the pulse number kmax of one burst. When the value of the pulse number k has not reached the pulse number kmax (S57:NO), the laser control processor 30 updates the value of the pulse number k by adding 1 to the value of k in S58, and returns processing to S54. When the value of the pulse number k has reached the pulse number kmax (S57:YES), since one burst has been completed, the laser control processor 30 ends processing of the present flowchart and returns to processing shown in FIG. 15 or FIG. 21.

### 2.3.5.1 Calculation of Corrected Operation Parameter Value Ac (k)

FIG. 24 is a flowchart showing an example of processing of calculating the corrected operation parameter value Ac(k). FIG. 24 corresponds to a subroutine of S54 of FIG. 23.

In S541, the laser control processor 30 reads the target value Lt(k) of the laser light parameter L acquired in FIG. 19.

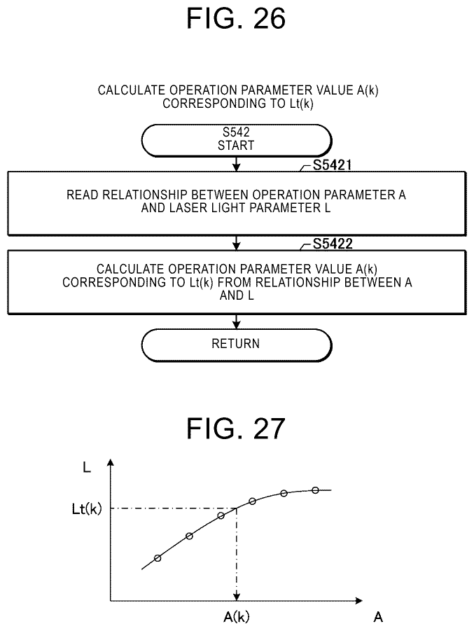

In S542, the laser control processor 30 calculates the operation parameter value A(k) corresponding to the target value Lt(k). At this time, the correction by the correction parameter value ΔAc(k) is not performed. Details of S542 will be described later with reference to FIGS. 26 and 27.

In S543, the laser control processor 30 reads the correction parameter value ΔAc(k) from the parameter table PT.

In S544, the laser control processor 30 calculates the corrected operation parameter value Ac(k) by adding the correction parameter value ΔAc(k) to the operation parameter value A(k). When the correction parameter value ΔAc(k) is 0, the corrected operation parameter value Ac(k) is the same value as the operation parameter value A(k).

In S545, the laser control processor 30 controls the actuator using the corrected operation parameter value Ac(k). When the laser light parameter L to be controlled is the pulse energy E, the actuator is the power source 12, when the laser light parameter L to be controlled is the wavelength λ, the actuator is the rotation stage 14e, and when the laser light parameter L to be controlled is the spectral line width Δλ, the actuator is the linear stage 15d. By starting the control of the actuator before advancing processing to S546, driving of the actuator can be completed at an early stage to be in time for laser oscillation of one pulse in S55 (see FIG. 23).

In S546, the laser control processor 30 writes the correction parameter value ΔAc(k) into the parameter table PT as an old correction parameter value ΔAcp(k). The old correction parameter value ΔAcp(k) is a correction parameter value having been used in laser oscillation, and is used to update the correction parameter value ΔAc(k) in S56 (see FIG. 23). After S546, the laser control processor 30 ends processing of the present flowchart and returns to processing shown in FIG. 23.

FIG. 25 shows an example of the parameter table PT. The correction parameter value ΔAc(k) is stored in association with the pulse number k of pulses included in one burst and the pulse time interval ΔT(k). Further, the old correction parameter value ΔAcp(k) is stored in association with the above. Further, the target value Lt(k) (see FIG. 20) of the laser light parameter L may be stored in association with the above.

FIG. 26 is a flowchart showing an example of processing of calculating the operation parameter value A(k) corresponding to the target value Lt(k). FIG. 26 corresponds to a subroutine of S542 of FIG. 24.

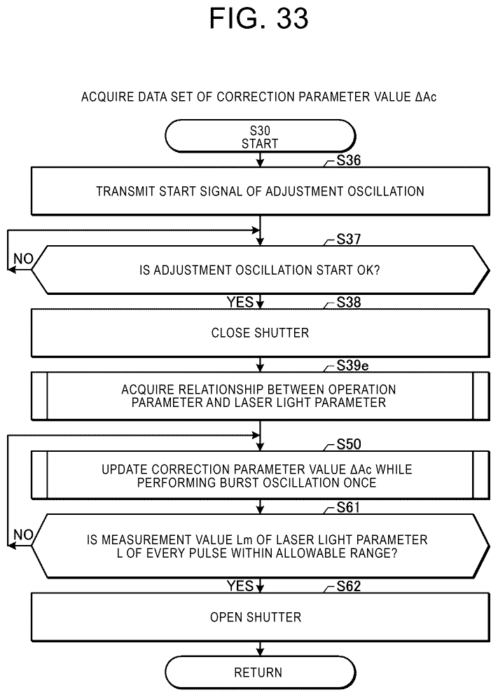

In S5421, the laser control processor 30 reads the relationship between the operation parameter value A and the value of the laser light parameter L. The relationship between the operation parameter value A and the value of the laser light parameter L may be acquired by performing separate adjustment oscillation, which will be described later with reference to FIGS. 33 to 36, and may be stored in the memory 31.

In S5422, the laser control processor 30 calculates the operation parameter value A(k) corresponding to the target value Lt(k) of the laser light parameter L based on the relationship between the operation parameter value A and the value of the laser light parameter L. After S5422, the laser control processor 30 ends processing of the present flowchart and returns to processing shown in FIG. 24.

FIG. 27 is a graph exemplifying a method of calculating the operation parameter value A(k) from the relationship between the operation parameter value A and the value of the laser light parameter L. The relationship between the operation parameter value A and the value of the laser light parameter L may be represented by an approximate expression or may be represented by table data. When the relationship between the operation parameter value A and the value of the laser light parameter L is expressed by an approximate expression, the operation parameter value A(k) corresponding to the target value Lt(k) can be calculated from the approximate expression. When the relationship between the operation parameter value A and the value of the laser light parameter L is represented by table data and data corresponding to the target value Lt(k) is not included in the table data, the operation parameter value A(k) may be calculated by linear interpolation.

### 2.3.5.2 Calculation of Correction Parameter Value ΔAc(k) for Next Burst

FIG. 28 is a flowchart showing an example of processing of calculating the correction parameter value ΔAc(k) for the next burst. FIG. 28 corresponds to a subroutine of S56 of FIG. 23.

In S561, the laser control processor 30 acquires the measurement value Lm(k) of the laser light parameter L of the pulse laser light generated in S55 (see FIG. 23) from the laser light parameter measurement instrument 16.

In S562, the laser control processor 30 calculates a difference Le(k) between the measurement value Lm(k) and the target value Lt(k) by the following expression.

Le(k)=Lt(k)−Lm(k)

In S563, the laser control processor 30 reads the old correction parameter value ΔAcp(k) from the parameter table PT.

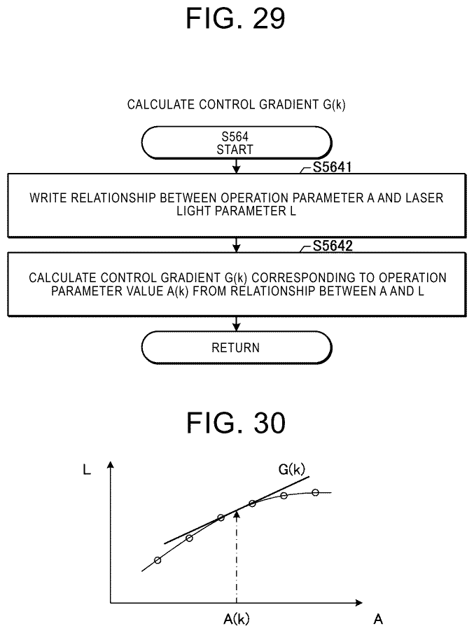

In S564, the laser control processor 30 calculates a control gradient G(k) corresponding to the operation parameter value A(k). Details of S564 will be described later with reference to FIGS. 29 and 30.

In S565, the laser control processor 30 calculates the correction parameter value ΔAc(k) by adding a value obtained by dividing the difference Le(k) by the control gradient G(k) to the old correction parameter value ΔAcp(k).

In S566, the laser control processor 30 writes the correction parameter value ΔAc(k) calculated in S565 into the parameter table PT. The correction parameter value ΔAc(k) is used to correct, in the next burst, the operation parameter value A(k) in S54 (see FIG. 23). After S566, the laser control processor 30 ends processing of the present flowchart and returns to processing shown in FIG. 23. Returning to FIG. 23, before laser oscillation of the next pulse in the current burst (S55), the correction parameter value ΔAc(k) for the next burst is calculated.

FIG. 29 is a flowchart showing an example of processing of calculating the control gradient G(k). FIG. 29 corresponds to a subroutine of S564 of FIG. 28.

In S5641, the laser control processor 30 reads the relationship between the operation parameter value A and the value of the laser light parameter L. The relationship between the operation parameter value A and the value of the laser light parameter L may be the same as that read in FIG. 26.

In S5642, the laser control processor 30 calculates the control gradient G(k) corresponding to the operation parameter value A(k) based on the relationship between the operation parameter value A and the value of the laser light parameter L. After S5642, the laser control processor 30 ends processing of the present flowchart and returns to processing shown in FIG. 28.

FIG. 30 is a graph exemplifying a method of calculating the control gradient G(k) from the relationship between the operation parameter value A and the value of the laser light parameter L. When the relationship between the operation parameter value A and the value of the laser light parameter L is expressed by an approximate expression, a differential value of the approximate expression at the operation parameter value A(k) may be set as the control gradient G(k). When the relationship between the operation parameter value A and the value of the laser light parameter L is represented by table data, the control gradient G(k) may be calculated from the gradient between a plurality of measurement points close to the operation parameter value A(k).

### 2.4 Effect

(1) According to the first embodiment, the laser device 1a includes the laser oscillator 17 that generates pulse laser light, the actuator such as the power source 12, the rotation stage 14e, and the linear stage 15d that each adjust the laser light parameter L of the pulse laser light, and the laser control processor 30. The laser control processor 30 corrects the operation parameter value A of the actuator so that the difference Le between the measurement value Lm and the target value Lt of the laser light parameter L becomes small based on the change pattern of the pulse time interval ΔT of the pulse laser light continuously changing within the burst of burst oscillation in accordance with a command of the exposure apparatus 100, and controls the actuator.

When the pulse time interval ΔT changes continuously, the measurement value Lm may not be stabilized at the vicinity of the target value Lt only by correction corresponding to the pulse time interval ΔT. By correcting the operation parameter value A based on the change pattern of the pulse time interval ΔT, the difference Le between the measurement value Lm and the target value Lt can be within the allowable range.

(2) According to the first embodiment, the laser control processor 30 calculates the correction parameter value ΔAc of each pulse based on the difference Le between the measurement value Lm and the target value Lt of each pulse of a plurality of consecutive pulses in the first burst, and corrects the operation parameter value A calculated based on the target value Lt in the second burst after the first burst based on the correction parameter value ΔAc.

Accordingly, since at least a part of the change pattern of the pulse time interval ΔT is often common among bursts, by applying the correction parameter value ΔAc calculated in the first burst to the second burst, appropriate correction based on the change pattern of the pulse time interval ΔT can be performed.

(3) According to the first embodiment, the laser control processor 30 calculates the correction parameter value ΔAc to be used in the second burst after the first burst while generating the pulse laser light in the first burst.

Accordingly, since the correction parameter value ΔAc is calculated based on the difference Le between the measurement value Lm and the target value Lt in the first burst while generating the pulse laser light in the first burst, the correction parameter value ΔAc can be calculated at an early stage.

(4) According to the first embodiment, the laser control processor 30 starts, after the pulse laser light of the first pulse in the first burst is output and before the pulse laser light of the second pulse next to the first pulse is output, the calculation of the correction parameter value ΔAc to be used in the second burst after the first burst.

Accordingly, since the calculation is started before the next pulse is output, the correction parameter value ΔAc can be calculated at an early stage.

(5) According to the first embodiment, the laser control processor 30 calculates the correction parameter value ΔAc based on the old correction parameter value ΔAcp of each pulse used in the first burst and the difference Le between the measurement value Lm and the target value Lt of each pulse in the first burst.

Accordingly, since the old correction parameter value ΔAcp is used, the accuracy of the correction parameter value ΔAc to be used in the next burst can be improved.

(6) According to the first embodiment, the laser control processor 30 calculates the correction parameter value ΔAc(k) by adding the value obtained by dividing the difference Le(k) by the control gradient G(k) obtained based on the operation parameter value A(k) to the old correction parameter value ΔAcp(k).

Accordingly, since an optimum control gradient G(k) can be changed in accordance with the operation parameter value A(k), an appropriate correction parameter value ΔAc(k) can be calculated by obtaining an appropriate control gradient G(k) in accordance with the operation parameter value A(k).

(7) According to the first embodiment, the laser control processor 30 is configured to be accessible to the parameter table PT storing the correction parameter value ΔAc of each pulse in the change pattern, and corrects, based on the correction parameter value ΔAc, the operation parameter value A of each pulse calculated based on the target value Lt.

Accordingly, by accessing the parameter table PT, it is possible to quickly correct the operation parameter value A.

(8) According to the first embodiment, the laser control processor 30 is configured to be accessible to the parameter table PT being different for each change pattern, and determines the parameter table PT from which the correction parameter value ΔAc is read based on the change pattern.

Accordingly, even when the change pattern of the pulse time interval ΔT changes, an appropriate correction parameter value ΔAc can be obtained.

(9) According to the first embodiment, the parameter table PT stores the data of the pulse time interval ΔT and the correction parameter value ΔAc of each pulse in association with each other.

Accordingly, when there is past data corresponding to the same change pattern, the past correction parameter value ΔAc can be used.

(10) According to the first embodiment, the parameter table PT includes the correction parameter value ΔAc of each pulse included in one burst.

Accordingly, by using the parameter table PT corresponding to one burst, it is unnecessary to read a plurality of the parameter tables PT in one burst, and the operation parameter value A can be efficiently corrected.

(11) According to the first embodiment, the parameter table PT is configured to store the correction parameter value ΔAc and the old correction parameter value ΔAcp used in past as the correction parameter value ΔAc. The laser control processor 30 reads the correction parameter value ΔAc for correction of the operation parameter value A, stores the correction parameter value ΔAc in the parameter table PT as the old correction parameter value ΔAcp, updates the correction parameter value ΔAc using the old correction parameter value ΔAcp, and stores the updated correction parameter value ΔAc in the parameter table PT.

Accordingly, by separately storing the correction parameter value ΔAc and the old correction parameter value ΔAcp, it is possible to smoothly perform correction of the operation parameter value A using the correction parameter value ΔAc and updating of the correction parameter value ΔAc using the old correction parameter value ΔAcp and the measurement value Lm.

(12) According to the first embodiment, the laser control processor 30 performs the first adjustment oscillation in which the pulse laser light is generated based on the change pattern of the pulse time interval ΔT and the target value Lt of the laser light parameter L, acquires the measurement value Lm, and creates the parameter table PT by calculating the correction parameter value ΔAc of each pulse based on the difference Le between the target value Lt and the measurement value Lm of each pulse.

Accordingly, an appropriate correction parameter value ΔAc can be obtained by performing adjustment oscillation.

(13) According to the first embodiment, the laser control processor 30 performs, a plurality of times, processing of creating the parameter table PT by performing the first adjustment oscillation, and ends the first adjustment oscillation when the difference Le between the target value Lt and the measurement value Lm becomes within the allowable range.

Accordingly, the accuracy of the correction parameter value ΔAc is improved by performing adjustment oscillation a plurality of times, and an appropriate correction parameter value ΔAc can be obtained by performing adjustment oscillation until the difference Le becomes within the allowable range.

In other respects, the first embodiment is similar to the comparative example.

### 3. Laser Device 1a in which Correction Parameter Value ΔAc is not Updated During Exposure

### 3.1 Operation

### 3.1.1 Main Flow

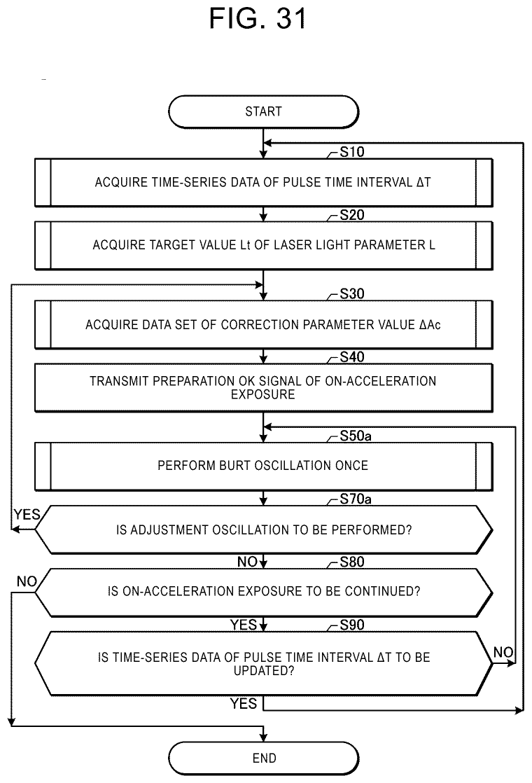

FIG. 31 is a flowchart of the laser control in a first modification of the first embodiment. The configuration of the first modification is similar to that described with reference to FIG. 14. In the laser control in the first modification, processes of S50a and S70a are performed instead of S50 of FIG. 15.

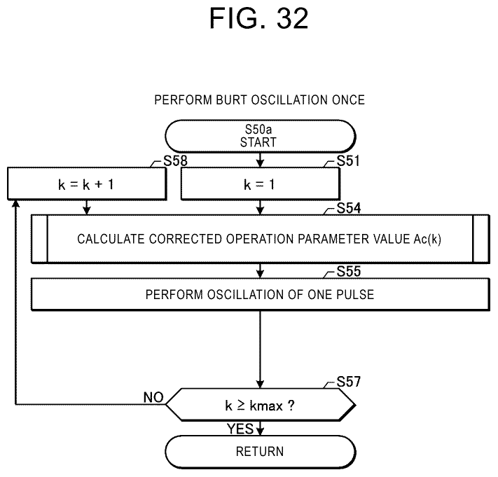

In S50a, the laser control processor 30 performs burst oscillation once using the correction parameter value ΔAc. However, updating of the correction parameter value ΔAc is not performed. Details of S50a will be described later with reference to FIG. 32.

In S70a, the laser control processor 30 determines whether or not to perform adjustment oscillation. For example, when a sufficient pause period is expected such as when replacement of the semiconductor wafer WF or the reticle is to be performed in the exposure apparatus 100, it is determined to perform adjustment oscillation. Alternatively, it may be determined whether or not an adjustment oscillation start OK signal is received from the exposure control processor 110, and S37 of FIG. 21 may be omitted in this case. Alternatively, when the difference between the measurement value Lm and the target value Lt of the laser light parameter L becomes larger than a threshold, it may be determined to perform adjustment oscillation. When adjustment oscillation is to be performed (S70a:YES), the laser control processor 30 returns processing to S30. In S30, as described with reference to FIG. 21, the process of S50 is performed and the process of S50a is not performed. When adjustment oscillation is not to be performed (S70a:NO), the laser control processor 30 returns processing to S80.

### 3.1.2 Burst Oscillation

FIG. 32 is a flowchart showing an example of processing of performing burst oscillation once. FIG. 32 corresponds to a subroutine of S50a of FIG. 31. FIG. 32 is different from FIG. 23 in that the process of S56 is not included.

### 3.2 Effect

(14) In the first modification of the first embodiment, when the first adjustment oscillation is not performed between the first burst and the second burst after the first burst, the laser control processor 30 corrects the operation parameter value A using the same data set of the correction parameter value ΔAc in the first burst and the second burst.

Accordingly, when the variation in the characteristics of the laser device 1a during exposure is not large, the measurement value Lm of the laser light parameter L can be within the allowable range even without updating the correction parameter value ΔAc during exposure. Further, since the correction parameter value ΔAc is not updated during exposure, the correction parameter value ΔAc is not changed and the control can be stabilized.

In other respects, the first modification of the first embodiment is similar to the first embodiment.

### 4. Laser Device 1a in which Second Adjustment Oscillation is Performed

### 4.1 Operation

### 4.1.1 Acquisition of Data Set of Correction Parameter Value ΔAc

FIG. 33 is a flowchart showing an example of processing of acquiring the data set of the correction parameter value ΔAc in a second modification of the first embodiment. The configuration of the second modification is similar to that described with reference to FIG. 14. In the second modification, after S38 of FIG. 21 and before the first adjustment oscillation in S50, S39e is added and second adjustment oscillation is performed.

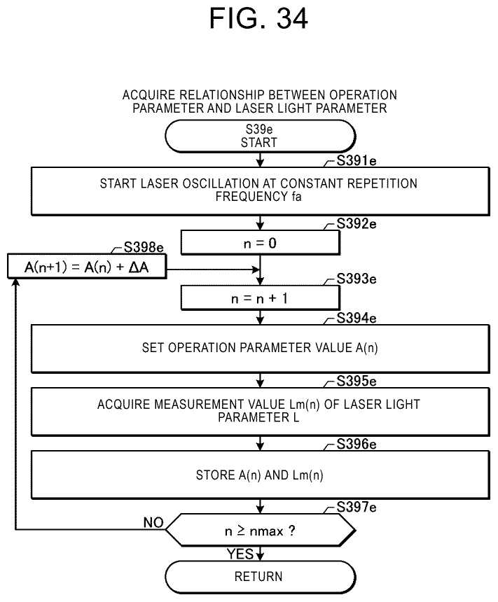

In S39e, the laser control processor 30 performs the second adjustment oscillation to obtain the relationship between the operation parameter value A and the value of the laser light parameter L. Details of S39e will be described later with reference to FIG. 34.

### 4.1.2 Second Adjustment Oscillation

FIG. 34 is a flowchart showing an example of processing of acquiring the relationship between the operation parameter value A and the value of the laser light parameter L in the second modification of the first embodiment. FIG. 34 corresponds to a subroutine of S39e of FIG. 33.

In S391e, the laser control processor 30 starts laser oscillation at a constant repetition frequency fa. The laser control processor 30 may generate the trigger signal Tr at the repetition frequency fa by the internal trigger oscillator 33. The repetition frequency fa is set to a repetition frequency at which the laser light parameter L is less likely affected by an acoustic wave, for example, equal to or less than 3 kHz, preferably equal to or more than 10 Hz and equal to or less than 1 kHz.

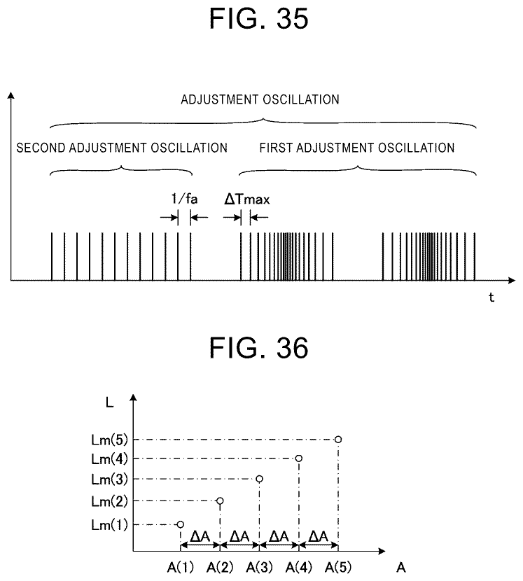

FIG. 35 shows an example of the trigger signal Tr in the first and second adjustment oscillation. The trigger signal Tr in the first adjustment oscillation causes the pulse time interval ΔT to continuously change in accordance with the change pattern of the pulse time interval ΔT. Let ΔTmax be the maximum value of the pulse time interval ΔT. Here, the maximum value of the pulse time interval ΔT does not include values during the pause period between bursts. On the other hand, the time interval of the pulses in the second adjustment oscillation is constant at the inverse 1/fa of the repetition frequency fa, and 1/fa is longer than ΔTmax.

Referring back to FIG. 34, in S392e, the laser control processor 30 sets the value of a counter n for counting a plot number nmax of the operation parameter value A to 0.

In S393e, the laser control processor 30 updates the value of the counter n by adding 1 to the value of n.

In S394e, the laser control processor 30 sets an operation parameter value A(n). For example, a first operation parameter value A(1) is set to a lower limit value of the operation parameter value A. The actuator is controlled in accordance with the set operation parameter value A(n) to generate the pulse laser light.

In S395e, the laser control processor 30 acquires a measurement value Lm(n) of the laser light parameter L of the generated pulse laser light from the laser light parameter measurement instrument 16. The measurement value Lm(n) may be a value obtained by averaging the measurement values Lm of a plurality of pulses of the pulse laser light.

In S396e, the laser control processor 30 stores the operation parameter value A(n) and the measurement value Lm(n) in association with each other.

In S397e, the laser control processor 30 determines whether or not the value of the counter n has reached the plot number nmax. When the value of the counter n has reached the plot number nmax (S397e:YES), the laser control processor 30 ends laser oscillation at the repetition frequency fa, and ends processing of the present flowchart. When the value of the counter n has not reached the plot number nmax (S397e:NO), the laser control processor 30 calculates a next operation parameter value A(n+1) by adding a step width DA to the current operation parameter value A(n), and then returns processing to S393e.

FIG. 36 shows an example of the relationship between the operation parameter value A and the value of the laser light parameter L acquired by the second adjustment oscillation. The measurement value Lm(n) is calculated for each operation parameter value A(n) and associated with each other, whereby the relationship between the operation parameter value A and the value of the laser light parameter L can be acquired.

### 4.2 Effect

(15) According to the second modification of the first embodiment, the laser control processor 30 performs the second adjustment oscillation for generating the pulse laser light while changing the operation parameter value A, acquires the relationship between the operation parameter value A and the measurement value Lm, and calculates either the operation parameter value A or the correction parameter value ΔAc based on the relationship.

Accordingly, since the relationship between the operation parameter value A and the value of the laser light parameter L is acquired by performing the second adjustment oscillation and the first adjustment oscillation is performed based on the relationship, the operation parameter value A (k) is calculated (see FIG. 27) or the control gradient G (k) is calculated (see FIG. 30) with high accuracy in the first adjustment oscillation, it is possible to calculate the correction parameter value ΔAc (k) with high accuracy. For example, since the characteristics of the laser device 1a may change due to a change in the gas composition inside the laser chamber 10, it is desirable to perform the second adjustment oscillation before the first adjustment oscillation each time the first adjustment oscillation is performed.

(16) According to the second modification of the first embodiment, the time interval 1/fa of the pulses in the second adjustment oscillation is longer than the longest time interval ΔTmax of the time intervals of the pulses that change according to the change pattern in the first adjustment oscillation.

Accordingly, the relationship between the operation parameter value A and the value of the laser light parameter L can be acquired under a condition that the influence of the variation of the pulse time interval ΔT is small, so that the correction taking into account the influence of the variation of the pulse time interval ΔT can be performed with high accuracy.

In other respects, the second modification is similar to the first embodiment. In the second modification, similarly to the first modification, the correction parameter value ΔAc may not be updated during exposure.

### 5. Laser Device 1a in which Pulse Energy E, Wavelength λ, and Spectral Line Width Δλ are Synchronously Controlled

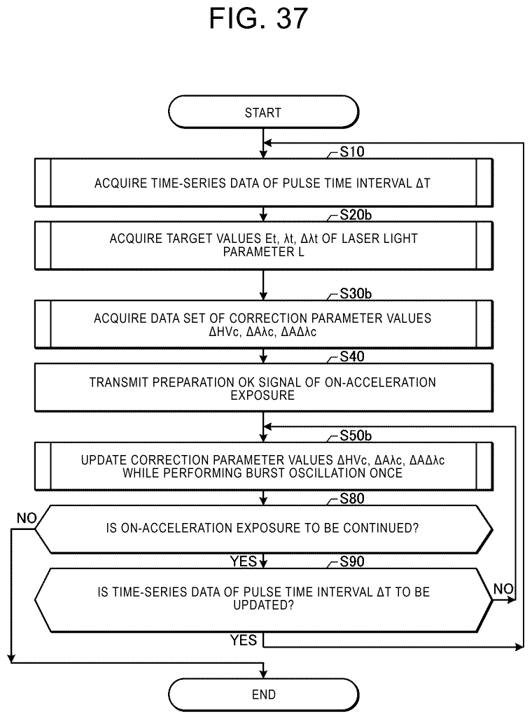

FIG. 37 is a flowchart of the laser control in a second embodiment. The configuration of the second embodiment is similar to that described with reference to FIG. 14. In the laser control in the second embodiment, the target values Et, λt, Δλt of the pulse energy E, the wavelength λ, and the spectral line width Δλ are acquired (S20b) instead of the target value Lt of the laser light parameter L.

In the second embodiment, instead of the correction parameter value ΔAc, the correction parameter value ΔHVc for correcting the set voltage value HV, the correction parameter value ΔAλc for correcting the set value Aλ of the rotation angle of the prism 14b, and the correction parameter value ΔAΔλc for correcting the set value AΔλ of the position of the cylindrical plano-concave lens 15c are acquired (S30b), and are updated (S50b).

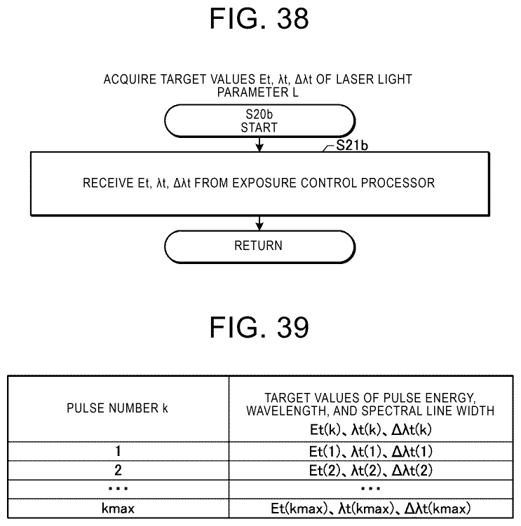

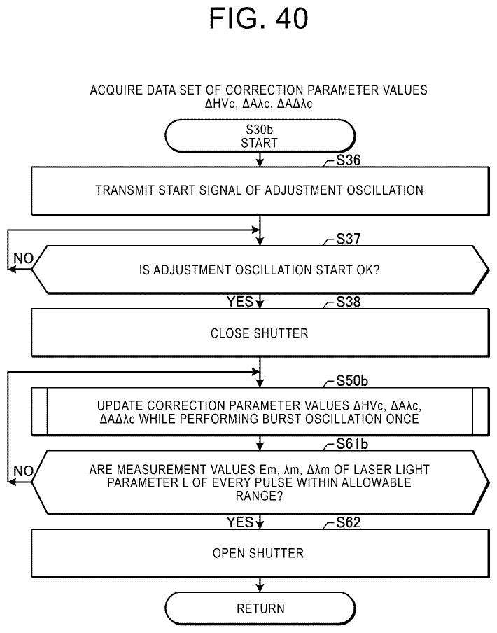

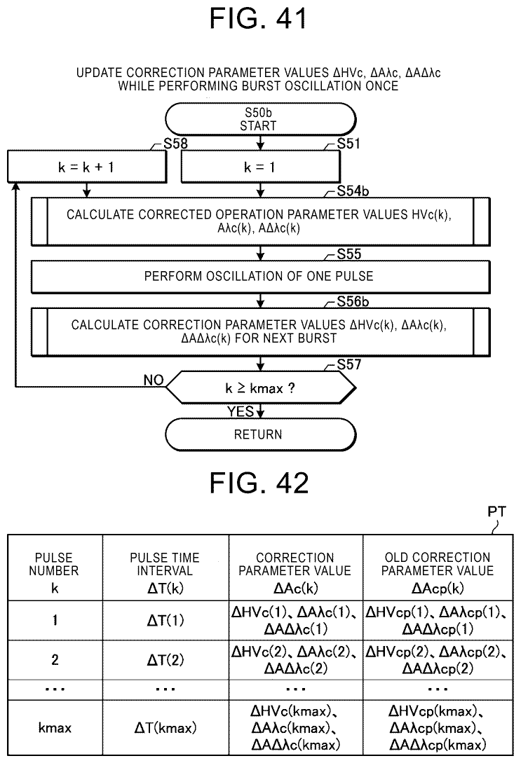

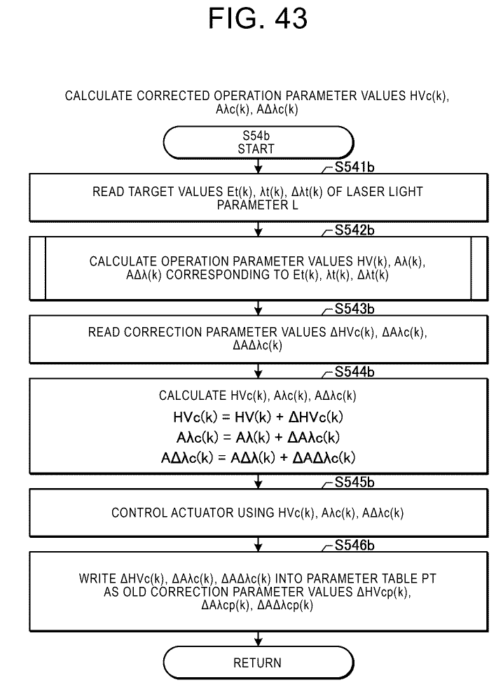

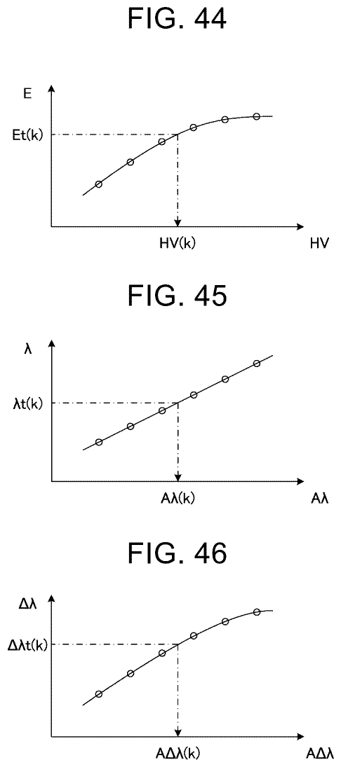

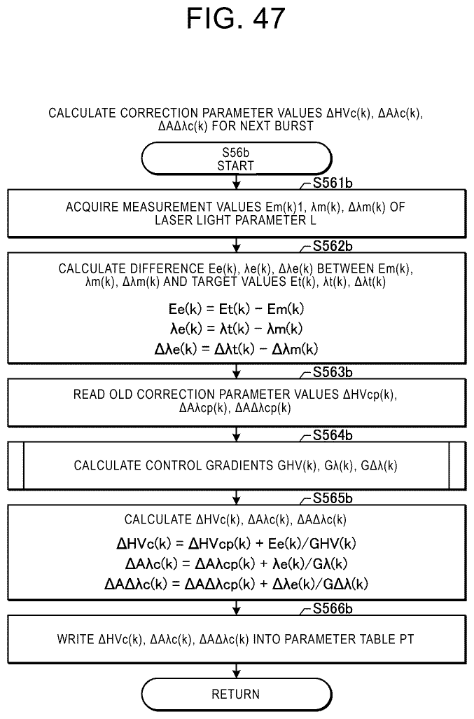

FIG. 38 is a flowchart showing an example of processing of acquiring the target value Lt of the laser light parameter L. FIG. 39 shows an example of the target value Lt of the laser light parameter L. FIG. 40 is a flowchart showing an example of processing of acquiring the data set of the correction parameter value ΔAc. FIG. 41 is a flowchart showing an example of processing of updating the correction parameter value ΔAc while performing burst oscillation once. FIG. 42 shows an example of the parameter table PT. FIG. 43 is a flowchart showing an example of processing of calculating the corrected operation parameter value Ac(k). FIGS. 44 to 46 are graphs each exemplifying a method of calculating the operation parameter value A(k) from the relationship between the operation parameter value A and the value of the laser light parameter L. FIG. 47 is a flowchart showing an example of processing of calculating the correction parameter value ΔAc(k) for the next burst. These figures are similar to the corresponding figures in the first embodiment except that the pulse energy E, the wavelength λ, and the spectral line width Δλ as the laser light parameter L are controlled in synchronization with each pulse of the pulse laser light.

The pulse energy E, the wavelength λ, and the spectral line width Δλ may change in conjunction with each other. Therefore, for example, if control of the wavelength λ and the spectral line width Δλ is changed after the pulse energy E becomes within an allowable range, the pulse energy E may change. As shown in FIG. 40, it is determined whether or not all of the measurement values Em, λm, Δλm are within respective allowable ranges (S61b). When any thereof is out of the corresponding allowable range (S61b:NO), all of the correction parameter values ΔHVc, ΔAλc, ΔAΔλc are updated (S50b), so that all of the measurement values Em, λm, Δλm can be brought close to the respective target values.

In other respects, the second embodiment is similar to the first embodiment. In the second embodiment, the correction parameter value ΔAc may not be updated during exposure as in the first modification of the first embodiment, or the second adjustment oscillation may be performed as in the second modification of the first embodiment.

### 6. Laser Device 1c that Receives Set Voltage Value HV from Exposure Apparatus 100

### 6.1 Configuration

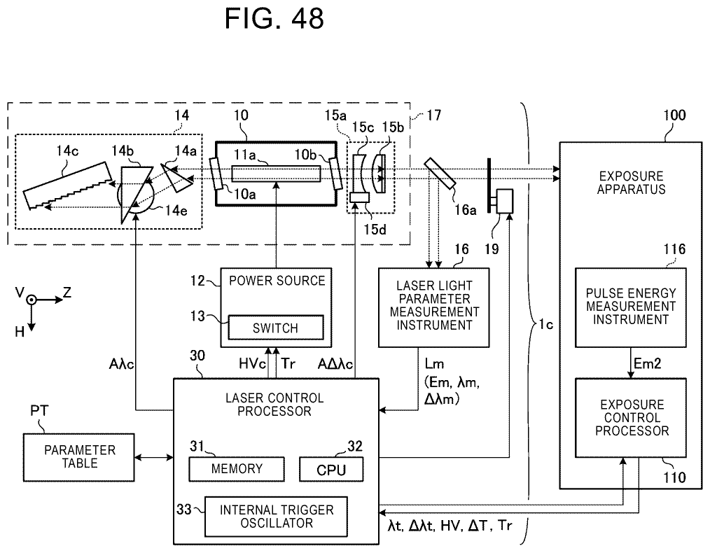

FIG. 48 schematically shows the configuration of a laser device 1c according to a third embodiment. In the third embodiment, the exposure apparatus 100 includes a pulse energy measurement instrument 116, and the pulse energy measurement instrument 116 outputs a measurement value Em2 of the pulse energy E to the exposure control processor 110. The exposure control processor 110 transmits the set voltage value HV for adjusting the pulse energy E to the laser control processor 30 instead of the target value Et of the pulse energy E.

### 6.2 Operation

### 6.2.1 Main Flow

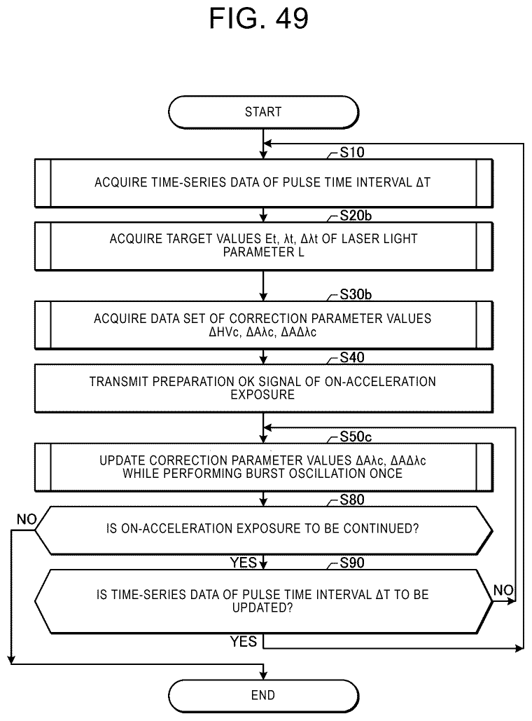

FIG. 49 is a flowchart of the laser control in the third embodiment. In the laser control in the third embodiment, the process of S50c is performed instead of S50b of FIG. 37.

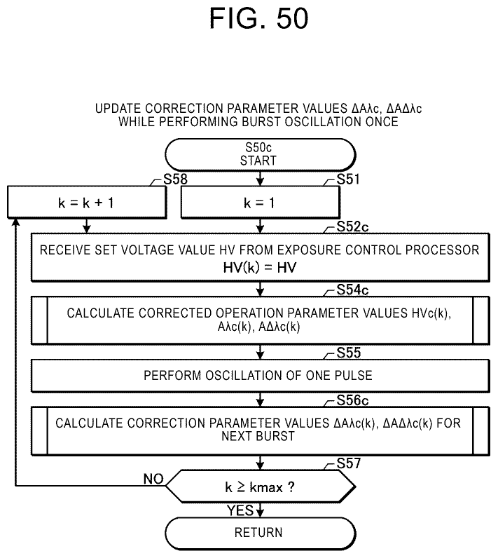

In S50c, the laser control processor 30 updates the correction parameter values ΔAλc, ΔAΔλc for the next burst while performing burst oscillation once using the correction parameter values ΔHVc, ΔAλc, ΔAΔλc. Here, the correction parameter value ΔHVc is not updated. This is because, in the exposure apparatus 100, feedback control of the set voltage value HV is performed for each pulse based on the measurement value Em2 of the pulse energy E, and there is a fear that the pulse energy E becomes unstable if the correction parameter value ΔHVc is updated during exposure. Details of S50c will be described later with reference to FIG. 50.

### 6.2.2 Burst Oscillation and Update of Correction Parameter Value ΔAc

FIG. 50 is a flowchart showing an example of processing of updating the correction parameter value ΔAc while performing burst oscillation once. FIG. 50 corresponds to a subroutine of S50c of FIG. 49. In FIG. 50, the processes of S52c and S54c are performed instead of S54b of FIG. 41, and the process of S56c is performed instead of S56b of FIG. 41.

In S52c, the laser control processor 30 receives the set voltage value HV from the exposure control processor 110. The laser control processor 30 stores the set voltage value HV in the memory 31 as a set voltage value HV(k) corresponding to the pulse number k.

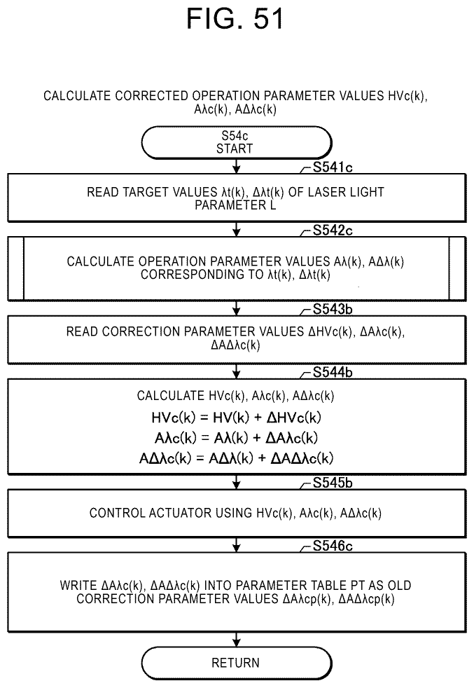

In S54c, the laser control processor 30 calculates a corrected set voltage value HVc(k), a corrected set value Aλc(k), and a corrected set value AΔλc(k) by correcting the set voltage value HV(k), a set value Aλ(k), and a set value AΔλ(k). Details of S54c will be described later with reference to FIG. 51.

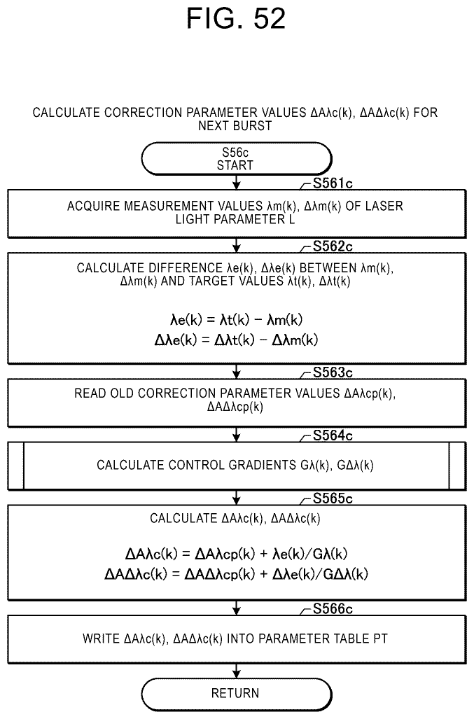

In S56c, the laser control processor 30 calculates correction parameter values ΔAλc(k), ΔAΔλc(k) for the next burst. Details of S56c will be described later with reference to FIG. 52.

### 6.2.2.1 Calculation of Corrected Operation Parameter Value Ac (k)

FIG. 51 is a flowchart showing an example of processing of calculating the corrected set voltage value HVc(k), the corrected set value Aλc(k), and the corrected set value AΔλc(k). FIG. 51 corresponds to a subroutine of S54c of FIG. 50. In FIG. 51, the processes of S541c and S542c are performed instead of S541b and S542b of FIG. 43, and the process of S546c is performed instead of S546b of FIG. 43.

In S541c, the laser control processor 30 may not read a target value Et(k) of the pulse energy E, and may not calculate the set voltage value HV(k) corresponding to the target value Et(k) in S542c. This is because the set voltage value HV(k) has already been acquired in S52c (see FIG. 50). The target value Et of the pulse energy E is used in adjustment oscillation (S30b of FIG. 49) but is not used during exposure (FIGS. 50 to 52), and therefore, a typical value thereof may only be determined in S20b of FIG. 49.

In S546c, the laser control processor 30 may not write a correction parameter value ΔHVc(k) into the parameter table PT as an old correction parameter value ΔHVcp(k). This is because if the correction parameter value ΔHVc(k) is updated in parallel with the feedback control for each pulse in the exposure apparatus 100, there is a fear that the pulse energy E becomes unstable.

### 6.2.2.2 Calculation of Correction Parameter Value ΔAc(k) for Next Burst

FIG. 52 is a flowchart showing an example of processing of calculating the correction parameter value ΔAc(k) for the next burst. FIG. 52 corresponds to a subroutine of S56c of FIG. 50. In FIG. 52, processing of calculating the correction parameter value ΔHVc(k) based on a measurement value Em(k) of the pulse energy E may not be performed.

### 6.3 Effect

According to the third embodiment, the laser light parameter L includes the pulse energy E. The laser control processor 30 receives, from the exposure apparatus 100, the set voltage value HV for adjusting the pulse energy E as the operation parameter value A, and corrects the set voltage value HV by using the data set of the same correction parameter value ΔAc in the first burst and the second burst.

Accordingly, since the correction parameter value ΔHVc(k) is not updated during exposure when the set voltage value HV is received from the exposure apparatus 100, the pulse energy E is suppressed from becoming unstable and control with high accuracy can be performed based on the set voltage value HV set by the exposure apparatus 100.

In other respects, the third embodiment is similar to the second embodiment. Alternatively, in the third embodiment, the second adjustment oscillation may be performed as in the second modification of the first embodiment.

### 7. Laser Device 1c in which Correction Parameter Value ΔAc is not Updated During Exposure

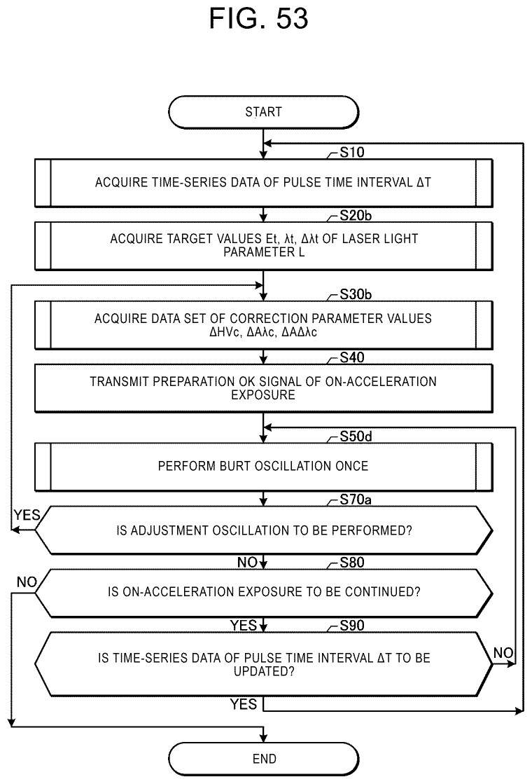

FIG. 53 is a flowchart of the laser control in a modification of the third embodiment. The configuration of the modification is similar to that described with reference to FIG. 48. In the laser control in the modification, processes of S50d and S70a are performed instead of S50c of FIG. 49.

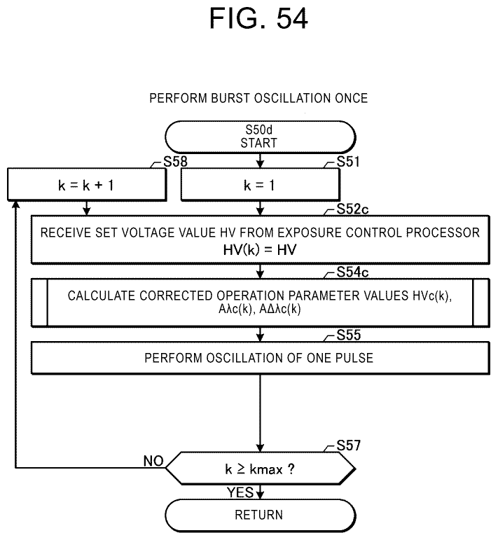

In S50d, the laser control processor 30 performs burst oscillation once using the correction parameter value ΔAc. However, updating of the correction parameter value ΔAc is not performed. Details of S50d will be described later with reference to FIG. 54.

The process of S70a is similar to that described with reference to FIG. 31.

FIG. 54 is a flowchart showing an example of processing of performing burst oscillation once. FIG. 54 corresponds to a subroutine of S50d of FIG. 53. FIG. 54 is different from FIG. 50 in that the process of S56c is not included.

In other respects, the modification of the third embodiment is similar to the third embodiment.

### 8. Laser Device 1d in which Spectral Line Width Δλ is Adjusted Depending on Discharge Timings of Laser Oscillator 17 and Laser Amplifier PO

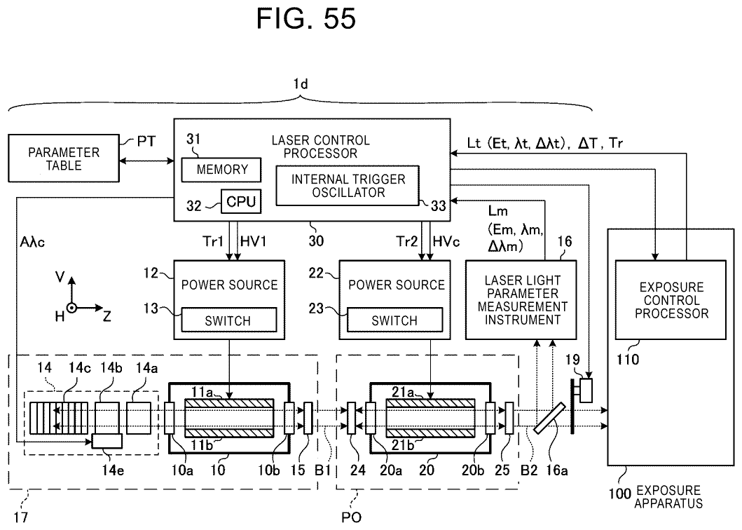

8.1 Configuration FIG. 55 schematically shows the configuration of a laser device 1d according to a fourth embodiment. In the laser device 1d, the laser oscillator 17 includes an output coupling mirror 15 instead of the spectrum adjuster 15a. One surface of the output coupling mirror 15 is coated with a partial reflection film. The output coupling mirror 15 may not have a function of adjusting the spectral line width Δλ.

The laser device 1d includes a laser amplifier PO between the laser oscillator 17 and the beam splitter 16a. The laser amplifier PO includes a laser chamber 20, discharge electrodes 21a, 21b, a rear mirror 24, and an output coupling mirror 25. The rear mirror 24 is made of a material that transmits the pulse laser light, and one surface thereof is coated with a partial reflection film. The reflectance of the rear mirror 24 is set higher than the reflectance of the output coupling mirror 25. The laser chamber 20 is arranged on the optical path of a laser resonator configured by the rear mirror 24 and the output coupling mirror 25. Windows 20a, 20b are provided at both ends of the laser chamber 20. The discharge electrodes 21a, 21b are arranged inside the laser chamber 20. A power source 22 is connected to the discharge electrode 21a, and the power source 22 is connected to a charger (not shown). The power source 22 includes a switch 23.

In other respects, the above-described components of the laser amplifier PO are similar to the corresponding components of the laser oscillator 17. Although an example of a Fabry-Perot resonator has been described as the optical resonator of the laser amplifier PO, the optical resonator is not limited to this example, and may be a ring resonator.

### 8.2 Operation

The laser control processor 30 sets a target value Et1 of a pulse energy E1 of pulse laser light B1 output from the laser oscillator 17. The laser control processor 30 further receives, from the exposure control processor 110, the target values Et, λt, Δλt of the pulse energy E, the wavelength λ, and the spectral line width Δλ of pulse laser light B2 output from the laser amplifier PO, the pulse time interval ΔT, and the trigger signal Tr.

The laser control processor 30 transmits set voltage values HV1, HVc to the power sources 12, 22, respectively, based on the target values Et1, Et. The laser control processor 30 transmits first and second trigger signals Tr1, Tr2 based on the trigger signal Tr to the power sources 12, 22, respectively.

The switch 23 included in the power source 22 is turned on when the second trigger signal Tr2 is received from the laser control processor 30. When the switch 23 is turned on, the power source 22 generates a pulse high voltage from the electric energy charged in the charger (not shown), and applies the high voltage to the discharge electrode 21a.

The timing of the second trigger signal Tr2 to the switch 23 with respect to the timing of the first trigger signal Tr1 to the switch 13 is controlled so that a second discharge timing at which discharge occurs inside the laser chamber 20 is synchronized, with a delay time 5T, with the first discharge timing at which discharge occurs inside the laser chamber 10.

The pulse laser light B1 generated by discharge in the laser chamber 10 and entering the laser chamber 20 reciprocates between the rear mirror 24 and the output coupling mirror 25, and is amplified each time the pulse laser light B1 passes through a discharge space in the laser chamber 20. The amplified pulse laser light B2 is output from the output coupling mirror 25.

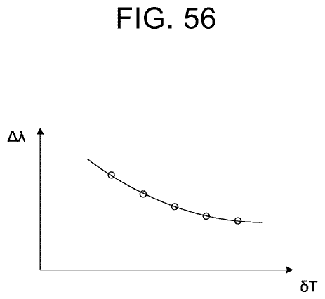

FIG. 56 is a graph showing the relationship between the delay time 5T of the second discharge timing with respect to the first discharge timing and the spectral line width Δλ of the pulse laser light B2 output from the laser amplifier PO. As the delay time δT becomes shorter, the spectral line width Δλ becomes larger, and as the delay time δT becomes longer, the spectral line width Δλ becomes smaller. Therefore, the spectral line width Δλ can be adjusted by the delay time δT. A delay circuit (not shown) for adjusting the delay time δT is an example of the actuator in the present disclosure.

The laser control processor 30 corrects the set value AΔλ of the delay time δT calculated from the target value Δλt of the spectral line width Δλ received from the exposure control processor 110 based on the correction parameter value ΔAΔλc, and sets the delay time δT by calculating the corrected set value AΔλc. Accordingly, the spectral line width Δλ of the pulse laser light B2 can be appropriately controlled even when the pulse time interval ΔT continuously changes within the burst. The laser control processor 30 calculates the correction parameter value ΔAΔλc for the next burst based on the difference between the measurement value Δλm and the target value Δλt of the spectral line width Δλ, and stores the correction parameter value ΔAΔc in the parameter table PT.

In the fourth embodiment, a case in which the spectral line width Δλ is adjusted by the delay time δT has been described, but the present disclosure is not limited thereto. The spectrum adjuster 15a (see FIG. 14) may be arranged at the position of the output coupling mirror 15, and the spectral line width Δλ may be adjusted by the spectrum adjuster 15a.

The laser control processor 30 corrects, based on the correction parameter value ΔHVc, the set voltage value HV calculated from the target value Et of the pulse energy E received from the exposure control processor 110, calculates the corrected set voltage value HVc, and controls the power source 22. Accordingly, the pulse energy E of the pulse laser light B2 can be appropriately controlled even when the pulse time interval ΔT continuously changes within the burst. The laser control processor 30 calculates the correction parameter value ΔHVc for the next burst based on the difference between the measurement value Em and the target value Et of the pulse energy E, and stores the correction parameter value ΔHVc in the parameter table PT.

In other respects, the fourth embodiment is similar to the first embodiment. Alternatively, in the fourth embodiment, the correction parameter value ΔAc may not be updated during exposure as in the first modification of the first embodiment, or the second adjustment oscillation may be performed as in the second modification of the first embodiment. Alternatively, in the fourth embodiment, the pulse energy E, the wavelength λ, and the spectral line width Δλ may be controlled synchronously as in the second embodiment. Alternatively, in the fourth embodiment, the set voltage value HV received from the exposure apparatus 100 may be used as in the third embodiment.

### 9. Laser Device 1e Including Solid State Laser

### 9.1 Configuration

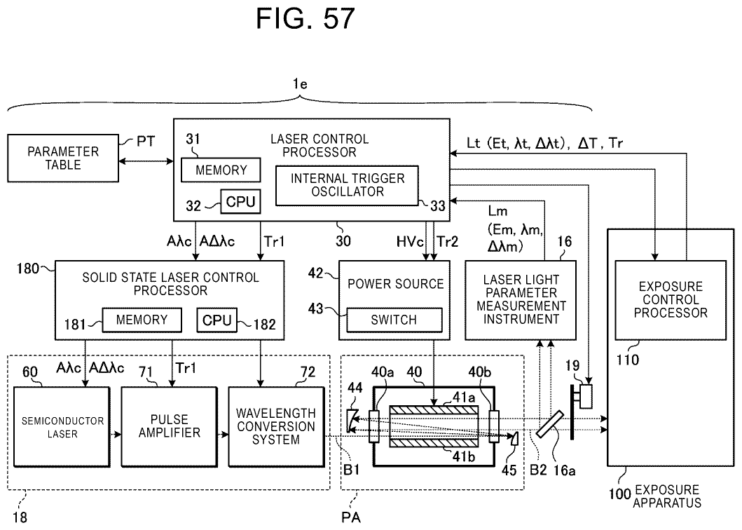

FIG. 57 schematically shows the configuration of a laser device 1e according to a fifth embodiment. The laser device 1e includes a laser oscillator 18, a solid state laser control processor 180, and a laser amplifier PA. The laser oscillator 18 includes a solid state laser, and the laser amplifier PA includes a laser chamber accommodating an excimer laser gas.

### 9.1.1 Laser Oscillator 18

The solid state laser control processor 180 is a processing device including a memory 181 in which a control program is stored and a CPU 182 which executes the control program. The solid state laser control processor 180 is specifically configured or programmed to perform various processes included in the present disclosure.

The laser oscillator 18 includes a semiconductor laser 60, a pulse amplifier 71, and a wavelength conversion system 72. The semiconductor laser 60 includes a distributed feedback semiconductor laser (not shown). The distributed feedback semiconductor laser includes a semiconductor laser element (not shown), a Peltier element (not shown), and a function generator (not shown). Each of the Peltier element and the function generator is an example of the actuator in the present disclosure. The pulse amplifier 71 includes a titanium-sapphire crystal (not shown) and a pumping pulse laser. The titanium sapphire crystal is arranged on the optical path of CW laser light output from the semiconductor laser 60. The wavelength conversion system 72 includes a lithium triborate (LBO) crystal and a potassium beryllium fluoroborate (KBBF) crystal.

### 9.1.2 Laser Amplifier PA

The laser amplifier PA includes a laser chamber 40, discharge electrodes 41a, 41b, a concave mirror 44, and a convex mirror 45. The laser chamber 40 accommodates an argon gas as a rare gas. Windows 40a, 40b are provided at both ends of the laser chamber 40. The discharge electrodes 41a, 41b are arranged inside the laser chamber 40. A power source 42 is connected to the discharge electrode 41a, and the power source 42 is connected to a charger (not shown). The power source 42 includes a switch 43. The power source 42 is an example of the actuator in the present disclosure.

The convex mirror 45 is arranged on the optical path of the pulse laser light B1 having passed through the windows 40a, 40b of the laser chamber 40 after being output from the laser oscillator 18. The concave mirror 44 is arranged on the optical path of the pulse laser light B1 having passed through the windows 40a, 40b of the laser chamber 40 again after being reflected by the convex mirror 45. The focal points of the convex mirror 45 and the concave mirror 44 coincide with each other. Although an example of the laser amplifier PA has been described as an amplifier included in the laser device 1e, the amplifier is not limited to this example, and may be a laser amplifier PO including, for example, a ring resonator.

### 9.2 Operation

The laser control processor 30 receives, from the exposure control processor 110, the target values Et, λt, Δλt of the pulse energy E, the wavelength λ, and the spectral line width Δλ of the pulse laser light B2, the pulse time interval ΔT, and the trigger signal Tr.

The laser control processor 30 transmits the set voltage value HVc to the power source 42 based on the target value Et, and transmits the set values Aλc, AΔλc to the solid state laser control processor 180 based on the target values λt, Δλt. The laser control processor 30 transmits the first and second trigger signals Tr1, Tr2 based on the trigger signal Tr to the solid state laser control processor 180 and the power source 42, respectively. The solid state laser control processor 180 transmits the set values Aλc, AΔλc to the semiconductor laser 60, and transmits the first trigger signal Tr1 to the pulse amplifier 71.

In the semiconductor laser 60, the semiconductor laser element outputs continuous wave (CW) laser light having the wavelength of about 773.6 nm. By adjusting the temperature of the semiconductor laser element to the set value ΔAc by the Peltier element, the center wavelength of the CW laser light output from the semiconductor laser element is adjusted. Further, the center wavelength of the CW laser light is chirped by increasing and decreasing the current supplied to the semiconductor laser element at a high frequency by the function generator. The larger the amplitude of the current to be increased and decreased is, the larger the spectral line width of the integrated spectral waveform obtained by integrating the spectral waveform of the CW laser light within the pulse time width of the pulse laser light output from the pulse amplifier 71 is. The spectral line width is adjusted by adjusting the amplitude of the current to be increased and decreased to the set value AΔλc.

In the pulse amplifier 71, the titanium sapphire crystal is excited by pumping laser light output from a pumping pulse laser.

The titanium sapphire crystal amplifies the CW laser light incident within the excitation period in a pulsed manner, and outputs the pulse laser light toward the wavelength conversion system 72.

The wavelength conversion system 72 outputs the fourth harmonic of the pulse laser light output from the pulse amplifier 71 as the pulse laser light B1. The wavelength λ of the pulse laser light B1 is about 193.4 nm, which is the amplification wavelength of an ArF excimer configuring the laser amplifier PA. When the laser amplifier PA is configured of a KrF excimer, the configurations of the semiconductor laser 60 and the wavelength conversion system 72 are selected so as to output the pulse laser light B1 corresponding to the amplification wavelength.

A high voltage is applied between the discharge electrodes 41a, 41b so that discharge starts at the discharge space in the laser chamber 40 in synchronization with a timing at which the pulse laser light B1 from the laser oscillator 18 enters the laser chamber 40.

The pulse laser light B1 entering the laser amplifier PA passes through the discharge space in the laser chamber 40, is reflected by the convex mirror 45, and is given with a beam spread angle corresponding to the curvature of the convex mirror 45. The pulse laser light B1 passes through the discharge space in the laser chamber 40 again.

The pulse laser light B1 having passed through the laser chamber 40 after being reflected by the convex mirror 45 is reflected by the concave mirror 44 to be returned to substantially parallel light. The pulse laser light B1 passes through the discharge space in the laser chamber 40 once more, and is output to the outside of the laser amplifier PA as the pulse laser light B2.

Thus, the pulse laser light B1 is expanded in the beam width, and the pulse energy is amplified while the pulse laser light B1 passes through the discharge space three times.

The laser control processor 30 corrects, based on the correction parameter value ΔAλc, the set value Aλ of the temperature calculated from the target value λt of the wavelength λ received from the exposure control processor 110, and sets the temperature of the semiconductor laser element by calculating the corrected set value ΔAc. Accordingly, the wavelength λ of the pulse laser light B2 can be appropriately controlled even when the pulse time interval ΔT continuously changes within the burst. The laser control processor 30 calculates the correction parameter value ΔAλc for the next burst based on the difference between the measurement value λm and the target value λt of the wavelength λ, and stores the correction parameter value ΔAλc in the parameter table PT.

The laser control processor 30 corrects the set value AΔλ of the amplitude of the current calculated from the target value Δλt of the spectral line width Δλ received from the exposure control processor 110 based on the correction parameter value ΔAΔλc, and sets the amplitude of the current to be supplied to the semiconductor laser element by calculating the corrected set value AΔλc. Accordingly, the spectral line width Δλ of the pulse laser light B2 can be appropriately controlled even when the pulse time interval ΔT continuously changes within the burst. The laser control processor 30 calculates the correction parameter value ΔAΔλc for the next burst based on the difference between the measurement value Δλm and the target value Δλt of the spectral line width Δλ, and stores the correction parameter value ΔAΔλc in the parameter table PT. Here, in a case that the laser oscillator 18 is a solid state laser, even if the pulse time interval ΔT continuously changes within the burst, since the influence on the wavelength λ and the spectral line width Δλ is small, it is not always necessary to correct the set values Aλ, AΔλ.

The laser control processor 30 corrects, based on the correction parameter value ΔHVc, the set voltage value HV calculated from the target value Et of the pulse energy E received from the exposure control processor 110, calculates the corrected set voltage value HVc, and controls the power source 42. Accordingly, the pulse energy E of the pulse laser light B2 can be appropriately controlled even when the pulse time interval ΔT continuously changes within the burst. The laser control processor 30 calculates the correction parameter value ΔHVc for the next burst based on the difference between the measurement value Em and the target value Et of the pulse energy E, and stores the correction parameter value ΔHVc in the parameter table PT.

In other respects, the fifth embodiment is similar to the first embodiment. Alternatively, in the fifth embodiment, the correction parameter value ΔAc may not be updated during exposure as in the first modification of the first embodiment, or the second adjustment oscillation may be performed as in the second modification of the first embodiment. Alternatively, in the fifth embodiment, the pulse energy E, the wavelength λ, and the spectral line width Δλ may be controlled synchronously as in the second embodiment. Alternatively, in the fifth embodiment, the set voltage value HV received from the exposure apparatus 100 may be used as in the third embodiment.

### 10. Exposure Apparatus 100a that Corrects Operation Parameter Value A

### 10.1 Configuration

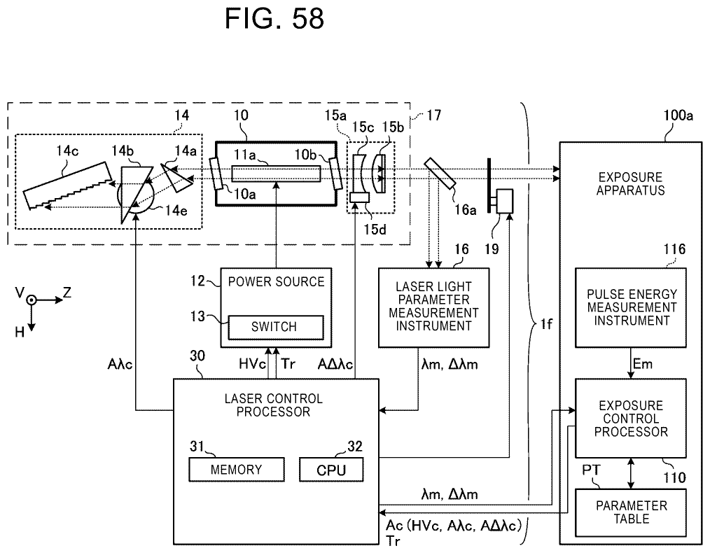

FIG. 58 schematically shows the configuration of an exposure apparatus 100a and a laser device 1f according to a sixth embodiment. The exposure apparatus 100a includes a pulse energy measurement instrument 116 and the parameter table PT. The laser device 1f may not include the internal trigger oscillator 33 and the parameter table PT.

### 10.2 Operation

The exposure control processor 110 corrects, based on the correction parameter value ΔAc stored in the parameter table PT, the operation parameter value A calculated based on the target value Lt of the laser light parameter L, and transmits the corrected operation parameter value Ac to the laser control processor 30. The laser control processor 30 may not calculate the corrected operation parameter value Ac. The laser control processor 30 controls the actuator using the corrected operation parameter value Ac received from the exposure control processor 110.

The exposure control processor 110 acquires the measurement value Lm of the laser light parameter L. For example, the exposure control processor 110 acquires the measurement value Em of the pulse energy E from the pulse energy measurement instrument 116, and acquires the measurement values λm, Δλm of the wavelength λ and the spectral line width Δλ from the laser control processor 30. The exposure control processor 110 updates the correction parameter value ΔAc based on the difference Le between the measurement value Lm and the target value Lt, and stores the correction parameter value ΔAc in the parameter table PT.

### 10.3 Effect

(18) According to the sixth embodiment, the exposure apparatus 100a is connectable to the laser device 1f including the laser oscillator 17 that generates the pulse laser light, the actuator that adjusts the laser light parameter L of the pulse laser light, and the laser control processor 30 that controls the actuator. The exposure apparatus 100a includes the projection optical system 102 and the exposure control processor 110. The projection optical system 102 forms an image on the wafer surface using the pulse laser light output from the laser device 1f. The exposure control processor 110 acquires the measurement value Lm of the laser light parameter L of the pulse laser light, corrects the operation parameter value A of the actuator so that the difference Le between the measurement value Lm and the target value Lt becomes small based on the change pattern of the pulse time interval ΔT of the pulse laser light continuously changing within the burst of the burst oscillation, and outputs the corrected operation parameter value A to the laser device 1f.

Accordingly, by correcting the operation parameter value A based on the change pattern of the pulse time interval ΔT, the difference Le between the measurement value Lm and the target value Lt can be within the allowable range.

(19) According to the sixth embodiment, the laser light parameter L includes the pulse energy E, and the exposure apparatus 100a further includes the pulse energy measurement instrument 116 that measures the pulse energy E. The exposure control processor 110 acquires the pulse energy E measured by the pulse energy measurement instrument 116 as the measurement value Lm, corrects the set voltage value HV for adjusting the pulse energy E as the operation parameter value A, and outputs the corrected operation parameter value A to the laser device 1f.

Accordingly, the pulse energy E can be controlled with high accuracy by using the pulse energy measurement instrument 116 included in the exposure apparatus 100a.

In other respects, the sixth embodiment is similar to the first embodiment. Alternatively, in the sixth embodiment, the correction parameter value ΔAc may not be updated during exposure as in the first modification of the first embodiment, or the exposure control processor 110 may output the trigger signal Tr or another signal so that the laser device 1f performs the second adjustment oscillation as in the second modification of the first embodiment. Alternatively, in the sixth embodiment, the pulse energy E, the wavelength λ, and the spectral line width Δλ may be controlled synchronously as in the second embodiment. Alternatively, in the sixth embodiment, the spectral line width Δλ may be controlled by the delay time δT between the first and second discharge timings given to the laser oscillator 17 and the laser amplifier PO, respectively, as in the fourth embodiment. Alternatively, in the sixth embodiment, a solid state laser may be used as the laser oscillator 18 as in the fifth embodiment.

### 11. Others

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious to those skilled in the art that the embodiments of the present disclosure would be appropriately combined.

The terms used throughout the present specification and the appended claims should be interpreted as non-limiting terms unless clearly described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more”. Further, “at least one of A, B, and C” should be interpreted to mean any of A, B, C, A+B, A+C, B+C, and A+B+C as well as to include combinations of any thereof and any other than A, B, and C.

What is claimed is:

1. A laser device, comprising:
a laser oscillator configured to generate pulse laser light;
an actuator configured to adjust a laser light parameter of the pulse laser light; and
a laser control processor configured to correct an operation parameter value of the actuator so that a difference between a measurement value and a target value of the laser light parameter becomes small based on a change pattern of a pulse time interval of the pulse laser light continuously changing within a burst of burst oscillation in accordance with a command of an exposure apparatus, and control the actuator.

2. The laser device according to claim 1,
wherein the laser control processor calculates a correction parameter value of each pulse based on the difference between the measurement value and the target value of each pulse of a plurality of consecutive pulses in a first burst, and corrects the operation parameter value, calculated based on the target value in a second burst after the first burst, based on the correction parameter value.

3. The laser device according to claim 2,
wherein the laser control processor calculates the correction parameter value to be used in the second burst while generating the pulse laser light in the first burst.

4. The laser device according to claim 2,
wherein the laser control processor starts, after a first pulse in the first burst is output and before a second pulse next to the first pulse is output, the calculation of the correction parameter value to be used in the second burst.

5. The laser device according to claim 2,
wherein the laser control processor calculates the correction parameter value based on an old correction parameter value of each pulse used in the first burst and the difference between the measurement value and the target value of each pulse in the first burst.

6. The laser device according to claim 5,
wherein the laser control processor calculates the correction parameter value by adding a value obtained by dividing the difference by a control gradient obtained based on the operation parameter value to the old correction parameter value.

7. The laser device according to claim 1,
wherein the laser control processor is accessible to a table storing a correction parameter value of each pulse in the change pattern, and corrects, based on the correction parameter value, the operation parameter value of each pulse calculated based on the target value.

8. The laser device according to claim 7,
wherein the laser control processor is accessible to the table being different for each change pattern, and determines the table from which the correction parameter value is read based on the change pattern.

9. The laser device according to claim 7,
wherein the table stores data of the pulse time interval and the correction parameter value of each pulse in association with each other.

10. The laser device according to claim 7,
wherein the table includes the correction parameter value of each pulse included in one burst.

11. The laser device according to claim 7,
wherein the table stores the correction parameter value and an old correction parameter value used in past as the correction parameter value, and
the laser control processor reads the correction parameter value for correction of the operation parameter value, stores the correction parameter value in the table as the old correction parameter value, updates the correction parameter value using the old correction parameter value, and stores the updated correction parameter value in the table.

12. The laser device according to claim 7,
wherein the laser control processor performs first adjustment oscillation for generating the pulse laser light based on the change pattern and the target value, acquires the measurement value, and creates the table by calculating the correction parameter value of each pulse based on the difference between the target value and the measurement value of each pulse.

13. The laser device according to claim 12,
wherein the laser control processor performs, a plurality of times, processing of creating the table by performing the first adjustment oscillation, and ends the first adjustment oscillation when the difference between the target value and the measurement value becomes within an allowable range.

14. The laser device according to claim 12,
wherein, when the first adjustment oscillation is not performed between a first burst and a second burst after the first burst, the laser control processor corrects the operation parameter value using a same data set of the correction parameter value in the first burst and the second burst.

15. The laser device according to claim 12,
wherein the laser control processor performs second adjustment oscillation for generating the pulse laser light while changing the operation parameter value, acquires a relationship between the operation parameter value and the measurement value, and calculates either the operation parameter value or the correction parameter value based on the relationship.

16. The laser device according to claim 15,
wherein the pulse time interval in the second adjustment oscillation is longer than a longest pulse time interval among the pulse time intervals changing in accordance with the change pattern in the first adjustment oscillation.

17. The laser device according to claim 7,
wherein the laser light parameter includes a pulse energy, and
the laser control processor receives, from the exposure apparatus, a set voltage value for adjusting the pulse energy as the operation parameter value, and corrects the set voltage value by using a same data set of the correction parameter value in a first burst and a second burst.

18. An exposure apparatus connectable to a laser device including a laser oscillator that generates pulse laser light, an actuator that adjusts a laser light parameter of the pulse laser light, and a laser control processor that controls the actuator, the exposure apparatus comprising:
a projection optical system configured to form an image on a wafer surface using the pulse laser light output from the laser device; and
an exposure control processor configured to acquire a measurement value of the laser light parameter, correct an operation parameter value of the actuator so that a difference between the measurement value and a target value becomes small based on a change pattern of a pulse time interval of the pulse laser light continuously changing within a burst of burst oscillation, and output the corrected operation parameter value to the laser device.

19. The exposure apparatus according to claim 18,
further comprising a pulse energy measurement instrument configured to measure a pulse energy,
wherein the laser light parameter includes the pulse energy, and
the exposure control processor acquires the pulse energy measured by the pulse energy measurement instrument as the measurement value, corrects a set voltage value for adjusting the pulse energy as the operation parameter value, and outputs the corrected operation parameter value to the laser device.

20. An electronic device manufacturing method, comprising:
generating pulse laser light using a laser device;
outputting the pulse laser light to an exposure apparatus; and
exposing a photosensitive substrate to the pulse laser light in the exposure apparatus to manufacture an electronic device,
the laser device including:
a laser oscillator configured to generate the pulse laser light;
an actuator configured to adjust a laser light parameter of the pulse laser light; and
a laser control processor configured to correct an operation parameter value of the actuator so that a difference between a measurement value and a target value of the laser light parameter becomes small based on a change pattern of a pulse time interval of the pulse laser light continuously changing within a burst of burst oscillation in accordance with a command of the exposure apparatus, and control the actuator.

21. An electronic device manufacturing method, comprising:
generating pulse laser light using a laser device including a laser oscillator configured to generate the pulse laser light, an actuator configured to adjust a laser light parameter of the pulse laser light, and a laser control processor configured to control the actuator;
outputting the pulse laser light to an exposure apparatus including a projection optical system configured to form an image on a wafer surface using the pulse laser light output from the laser device and an exposure control processor configured to acquire a measurement value of the laser light parameter, correct an operation parameter value of the actuator so that a difference between the measurement value and a target value becomes small based on a change pattern of a pulse time interval of the pulse laser light continuously changing within a burst of burst oscillation, and output the corrected operation parameter value to the laser device; and
exposing a photosensitive substrate to the pulse laser light in the exposure apparatus to manufacture an electronic device.
